(19) United States
(12) Patent Application Publication
(10) Pub. No.: US 2025/0110486 A1
(43) Pub. Date: Apr. 3, 2025

(54) MANAGING PERFORMANCE OF ASSETS IN INDUSTRIAL FACILITIES

(71) Applicant: Honeywell International Inc., Charlotte, NC (US)

(72) Inventors: Viraj Srivastava, Bangalore (IN); Chinmaya Kar, Al Jubail (SA); Minal Dani, Bangalore (IN)

(21) Appl. No.: 18/818,604

(22) Filed: Aug. 29, 2024

(30) Foreign Application Priority Data
Sep. 29, 2023 (IN) 202311065802

(51) Int. Cl. G05B 19/418

(52) U.S. Cl. CPC G05B 19/41875; G05B 2219/32204

(57) ABSTRACT

Examples techniques to manage performance of assets installed in an industrial facility are described. Operating parameters of a component from amongst one or more components of an asset are monitored. A range of values indicative of normal operational behavior of the asset is predefined for each operating parameter of the component. One or more operating parameters of the component are identified to deviate from corresponding predefined range of values. Deviation in an operating parameter is a symptom of a fault. A severity index is assigned to each symptom of a fault based on an amount of the deviation in the respective operating parameter from corresponding predefined range of values. Further, a fault severity indicator is assigned for the fault associated with the component based on severity indexes of each symptom of the fault. A corrective action is caused when the fault severity indicator is above a predetermined threshold.

### BACKGROUND

Industrial facilities, such as manufacturing plants, chemical production sites, refineries specializing in oil, gas, or petrochemical substances, mining operations, and plants dedicated to the processing of ores. These facilities are characterized by their reliance on a broad spectrum of industrial assets, which are integral to the execution of various industrial processes. Such processes are typically designed to alter or refine products in a manner that adheres to pre-established specifications. The assets comprise a multitude of components, which may include, among others, sophisticated industrial machinery and equipment. These components are orchestrated to work in synergy, with the collective aim of achieving a predefined objective.

Within these industrial settings, the orchestration and management of the aforementioned industrial processes are typically entrusted to a specialized process control system. This system plays a central role in the regulation, supervision, and coordination of the utilization of industrial assets. Through the process control system, continuous monitoring of the industrial processes is made possible, thereby facilitating the identification or prediction of potential faults or failures that may arise in connection with the assets involved. Such proactive monitoring is instrumental in maintaining the integrity and continuity of the industrial process.

When anomalies, faults, or failures are detected, a series of corrective actions can be initiated. These actions are diverse in nature and may include, but are not limited to, comprehensive troubleshooting procedures, routine or emergency maintenance, the execution of repairs, and the implementation of strategies aimed at optimizing the performance and efficiency of the assets. Through these corrective measures, the reliability and productivity of the industrial process can be enhanced, ensuring that the industrial facility operates within the desired parameters of safety and efficiency.

### SUMMARY

Various embodiments of systems, methods, and non-transitory computer-readable media for managing performance of assets installed in an industrial facility are described herein.

The details of some embodiments of the subject matter described in this specification are set forth in the accompanying drawings and the description below. Other features, aspects, and advantages of the subject matter will become apparent from the description, the drawings, and the claims.

According to an embodiment of the present subject matter, a method for managing performance of an asset installed in an industrial facility is provided. According to the method, operating parameters of a component from amongst one or more components of the asset are monitored. A range of values is predefined for each of the operating parameters of the component and the range of values is indicative of normal operational behavior of the asset. One or more operating parameters of the component are identified to deviate from corresponding predefined range of values. Deviation in an operating parameter is a symptom of a fault. A severity index is assigned to each of one or more symptoms of a fault based on an amount of the deviation in the respective operating parameters from the corresponding predefined range of values. Further, a fault severity indicator is assigned for the fault associated with the component based on severity indexes of each of the one or more symptoms of the fault. Finally, a corrective action is caused when the fault severity indicator is above a predetermined threshold.

According to another embodiment of the present subject matter, a system for managing performance of assets involved in an industrial process is provided. The system comprises a processor. For a component or subsystem of an asset, the processor determines a first severity index of a first symptom of a fault associated with the component or the subsystem based on an amount of deviation in value of a first operating parameter of the component or the subsystem from a corresponding mean value indicative of acceptable values of the first operating parameter. The processor further determines a second severity index of a second symptom of the fault based on an amount of deviation in value of a second operating parameter of the component or the subsystem from a corresponding predefined mean value indicative of acceptable values of the second operating parameter. The processor calculates a fault severity indicator for the fault associated with the component or the subsystem by integrating the first severity index and the second severity index using data fusion operations. The processor also causes an alert notification to be generated based on the fault severity indicator of the fault.

According to yet another embodiment of the present subject matter, a non-transitory computer-readable medium comprising instructions executable by a processing resource to manage performance of assets in an industrial facility is provided. The instructions, when executed, cause the processing resource, for a component of an asset, to detect a first fault based on a symptom of the first fault associated with the component, and a second fault based on a symptom of the second fault associated with the component The symptom of a fault is a deviation in value of an operating parameter of the component from corresponding mean value. The mean value is indicative of normal operational behavior of the component of the asset. The instructions may also cause the processing resource to calculate a fault severity indicator for the first fault based on a severity index of the symptom of the first fault and for the second fault based on a severity index of the symptom of the second fault. The severity index of a symptom of a fault is based on an amount of deviation in value of the respective operating parameter from the corresponding predefined mean value. The instructions may cause the processing resource to determine a component level degradation indicator for the component by integrating the fault severity indicators of the first fault and the second fault using data fusion operations. The instructions further cause the processing resource to cause an alert notification to be generated based on the component level degradation indicator.

In accordance with example implementations of the present subject matter, the techniques for managing performance of assets in industrial facilities described herein, consider amount of deviation in values of operating parameters of a component or a subsystem of an asset for estimation of severity of a fault associated with the component or the subsystem. This provides for an accurate estimation of severity of the fault resulting in a more reliable indication of health of the component or the subsystem and early anomaly detection in the asset or the component or subsystem of the asset that might result in unplanned maintenance operations. Further, based on severity of faults, maintenance operations may be prioritized and planned. Accordingly, the techniques described herein provide for reducing the likelihood of asset failures, decreasing unplanned downtime of assets and minimizing maintenance costs associated with the assets.

### BRIEF DESCRIPTION OF FIGURES

The following detailed description references the drawings, wherein:

FIG. 1 illustrates a network environment for implementing example techniques to manage performance of assets involved in an industrial process, in accordance with an example implementation of the present invention;

FIG. 2 illustrates a system for managing performance of assets involved in an industrial process, in accordance with an example implementation of the present invention;

FIG. 3 illustrates the system for managing performance of assets involved in an industrial process, in accordance with another example implementation of the present invention;

FIG. 4 illustrates a schematic representation of a process to monitor performance of an asset involved in an industrial process by the system, in accordance with another example implementation of the present invention;

FIG. 5 illustrates a method for managing performance of an asset installed in an industrial facility, according to an example of the present invention;

FIG. 6 illustrates a method of determining a fault severity indicator for a fault associated with a component of an asset, according to another example implementation of the present invention;

FIG. 7 illustrates a method of managing maintenance operations for components of an asset involved in an industrial process, according to an example of the present invention;

FIG. 8 illustrates a method of determining an asset level degradation indicator of an asset involved in an industrial process, according to an example implementation of the present invention;

FIG. 9 illustrates a graphical representation of estimation of component level severity indicators for components of an asset, according to an example implementation of the present invention.

FIG. 10 illustrates graphical representation of estimation of subsystem level degradation indicator for a subsystem of an asset compressor, according to an example implementation of the present invention.

FIG. 11 illustrates graphical representation of estimation of asset level degradation indicator for the asset compressor, according to an example implementation of the present invention.

FIG. 12 illustrates a computing environment for managing performance of assets installed in an industrial facility, according to an example implementation of the present invention.

In the figures, the left-most digit(s) of a reference number identifies the figure in which the reference number first appears. The same numbers are used throughout the drawings to reference like features and components.

### DETAILED DESCRIPTION

As described above, industrial processes are carried out in an industrial facility. Industrial facilities generally rely on a wide range of industrial assets to achieve their productivity and financial objectives. These assets include various components, such as industrial machines and equipments for carrying out industrial processes such as compressors of several types such as Centrifugal, Reciprocating, Screw, Liquid Ring; pumps (of several types); and turbines and motors of different types. Additionally, the industrial facilities may include process control systems that regulate the operation of the assets, peripheral systems or devices that participate in assets' control or quality verification processes (e.g., quality check systems, industrial safety systems, motor drives, etc.). Typically, these assets are configured to operate in accordance with standard operating procedures (SOPs) that are tailored to meet the specific requirements of the industrial facility's processes. Adhering to these standard operating parameters ensures the safe and optimal performance of the assets within the industrial facility.

An asset may include one or more subsystems or components, each contributing different roles in the operation of the asset. For example, the asset may be an oil lubricated gas compressor comprising components like bearings, seals etc. and subsystems like lubrication oil subsystem, and dry gas seal or wet seal subsystem etc. Similarly, an asset may be centrifugal pump whose components are bearings, seals, shaft and impeller, while the subsystem will be lubricating oil subsystem for bearings and seal fluid supplying system as per different API 682 seal plan. A reciprocating compressor asset can have components like suction valve, discharge valves, piston or plunger, packings, crosshead, crankshaft, bearings of the crankshaft etc. and the subsystems can be cylinder lubricator system, packings seal system, packings' cooling system, cylinder jacket cooling water system, bearings and crosshead lubricating system etc. The performance of assets in the industrial facility may be managed through an asset performance management system (APM). APMs monitor, assess, maintain, and predict health or performance of assets installed in an industrial facility through failure mode effect analysis (FMEA). FMEA is a process of reviewing assets to identify failure modes and their causes and effects in the industrial process carried out in the industrial facility. Components or subsystems of an asset to be monitored to assess performance of the asset may be identified and defined during FMEA. The functionality of the asset management system may be integrated in the process control system managing the industrial process.

Operational state of an asset or components of the asset and their variable parameters may be controlled based on the SOP. The assets may be susceptible to experiencing downtime and occasional deviations from their normal or predefined operating parameters as defined by the SOP. The operating parameters may be monitored by the process control system or the APM system as the industrial process progresses to identify one or more symptoms of one or more faults associated with any of the assets. A fault which may be understood as an anomaly is said to occur in an asset if the behavior of the asset deviates from a normal operational behavior of the equipment. Normal operational behavior may be defined as behavior exhibited by the asset when the asset performs as per SOPs. A fault or an anomaly may be identified based on one or more symptoms. A symptom of a fault or an anomaly may be predefined based on the operational behavior of the asset deviating from the normal operation behavior, for example, temperature of a motor exceeding a maximum predefined value. Thus, based on values of operating parameters of an asset or a component or a subsystem of the asset that may be obtained from one or more associated sensors, symptoms of a fault or an anomaly may be identified. If the anomaly is not prevented by a corrective action in the industrial facility such as a maintenance activity, change in operational mode or a design change, then the anomaly may lead to failure of the asset. The failure may cause significant production loss or maintenance cost. The APM system of an industrial facility generally contains a list of all faults or anomalies that may occur in each of the assets in the industrial facility along with predefined symptoms of each fault. As described, a deviation in value of one or more operating parameters from the corresponding values as defined in the SOPs for the normal operational behavior of the asset may be indicative of a symptom of a fault.

The process control system or APM system may assign a fault index to a fault associated with a component or subsystem of an asset based on one or more symptoms of the fault. For instance, one or more symptoms of a fault of a component or subsystem of an asset as identified based on the deviations may be integrated through Boolean logical operators in an expression or function which may be predefined, for example, by the manufacturer of the component or the subject matter experts. The process control or APM systems may also predict a fault indicator for a component or subsystem of the asset based on the fault indexes of one or more identified faults in the component or the subsystem. As the name suggests, the fault indicator is indicative of likelihood of failure of the component or the subsystem. Consequently, based on the fault indicators of the one or more components or subsystems, fault indicator of the asset, also termed as asset degradation indicator herein, may be predicted by the process control system or the APM system.

However, the existing process control or APM system predicts the fault index that is static in nature. That is, occurrence of each symptom of a fault is determined based on an indication of deviation in the value of one or more operating parameters from their corresponding value defined by the SOPs and fault index is generated based merely on the occurrence of each symptom. Thus, the process control or APM system is not capable of identifying level of severity of a fault associated with a component or subsystem of the asset based on amount of deviation in one or more operating parameters. In other words, the process control system or APM system determines the fault index based on detection of occurrence of a symptom alone, i.e., based on the deviation of an operating parameter from its corresponding value defined in the SOP and not based on a magnitude of the deviation. Accordingly, conventionally, the fault index of a fault does not change in situations where the deviation may progressively increase, for example, from 10% deviation to 20% deviation to 30% deviation and so on. Thus, while the existing process control systems or APM systems work to provide an indication of existence of a fault in a component or subsystem of an asset, they fail to identify the severity of the fault. This leads to delay in corrective actions to be taken in an event of a fault in the component or the subsystem, since there is no indication of severity associated with the fault. Also, in case of multiple faults, there is no mechanism to assess which fault needs to be addressed on priority. Moreover, it is difficult to know which anomaly or fault occurred first and caused secondary damage in others. The root cause analysis to determine the exact failure also takes a long time due to unavailability of severity of fault indexes.

Since the fault indexes of the faults associated with each component or the subsystem of the asset is not dynamic or continuous, there is no mechanism to determine priority for each component or subsystem. Hence, in case of anomalies or faults in multiple components or subsystems, there is no mechanism to assess the priority of any maintenance action to be taken for any component or subsystem. Similarly, out of all the assets in an industrial facility, there is no mechanism to determine fault indicator or priority of any asset which makes it difficult to assign scarce maintenance resources to the assets requiring urgent maintenance. This leads to investment of significant amount of time in resolution of faults or failures, resulting in a less efficient operation of the industrial process.

According to example implementations of the present subject matter, techniques for managing performance of assets installed in an industrial facility are described.

According to the techniques described herein, operating parameters of a component from amongst one or more components of an asset may be monitored. In an example, operating parameters may comprise process, mechanical and electrical parameters to be set during operation of the asset or the component of the asset. A range of values may be predefined for each of the operating parameters of the component. The range of values may be indicative of normal operational behavior of the asset. In an example, normal operational behavior of the asset may be defined as behavior exhibited by the equipment when the asset or the component of the asset performs as per SOPs and standard practices. One or more operating parameters of the component may be identified to deviate from corresponding predefined range of values. Deviation in an operating parameter may be a symptom of a fault. A fault may be understood as an anomaly in the component or the asset. In an example, a symptom of a fault may be predefined based on the operational behavior of the asset deviating from the normal operation behavior. Thus, based on values of operating parameters of a component that may be obtained from one or more associated sensors, symptoms of a fault may be identified. In an example, faults for an asset and symptoms of each fault may be predefined. Further, a severity index may be assigned to each of one or more symptoms of the fault based on an amount of the deviation in the respective operating parameters from the corresponding predefined range of values. A fault severity indicator may be determined for the fault associated with the component or based on severity indexes of each of the one or more symptoms of the fault. In an example, fault severity indicator of a fault associated with a subsystem may also be determined in a similar manner. When the fault severity indicator is above a predetermined threshold, a corrective action may be caused.

Since, severity index of each symptom of a fault is determined based on amount of deviation in value of corresponding operating parameter, rather than merely based on an indication of deviation, the fault severity indicator for the fault generated by integrating the severity indexes of one or more symptoms of the fault provides a more reliable and accurate indication of health of the component or the subsystem of the asset. This also enables early anomaly or fault detection in the asset or the component or subsystem of the asset aiding prevention of production loss resulting from expensive shutdown of the asset which may otherwise happen if the fault is detected later during the operation of asset of the asset. Early detection of fault enables addressing primary damages and prevents secondary damages resulting from the primary damages. This further shortens the time and cost associated with maintenance activity which may otherwise be needed to address the secondary damage. Further, maintenance activity on the assets may be deferred or prioritized based on the severity of the fault. Such optimization of maintenance intervals leads to saving costs associated with production loss, maintenance, energy and emission that may occur as a result of frequent maintenance activity.

Indication of level of severity of fault provided through the techniques disclosed herein also enables efficient root cause analysis of the faults and consequently effective corrective actions may be taken for the mitigation or elimination of similar faults in future. In case of occurrence of multiple faults in the component or subsystem of the asset, the fault severity indicator may accurately indicate which fault needs to be addressed first. Also, maintenance of the assets, and the components or subsystems of the assets may be prioritized.

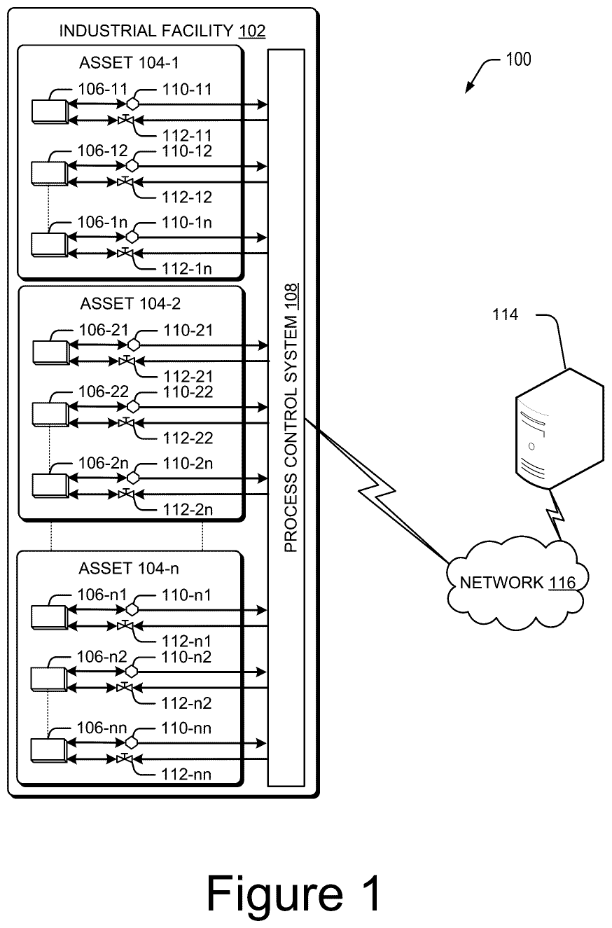

The above techniques are further described with reference to FIG. 1 to FIG. 9. It should be noted that the description and the Figures merely illustrate the principles of the present invention along with examples described herein and should not be construed as a limitation to the present invention. It is thus understood that various arrangements may be devised that, although not explicitly described or shown herein, embody the principles of the present invention. Moreover, all statements herein reciting principles, aspects, and implementations of the present invention, as well as specific examples thereof, are intended to encompass equivalents thereof.

FIG. 1 illustrates a network environment 100 for implementing examples techniques for managing performance of assets involved in an industrial process, in accordance with an example implementation of the present invention.

The industrial process is carried out in an industrial facility 102, such as oil refineries, chemical plants, paper mills, wherein multiple assets 104-1, 104-2, . . . , and 104-n, of the industrial facility 102 operate in conjunction with each other to accomplish a predefined task. The assets 104-1, 104-2, . . . , and 104-n may include various industrial equipments and machines and each asset may include one or more components or subsystems. For example, the asset 104-1 may have components and subsystems 106-11, 106-12, . . . , and 106-1n. Similarly, the asset 104-2 may have the components and subsystems 106-21, 106-22, . . . , and 106-2n. Each component, for example, the component 106-11 of asset 104-1 may be a part of the asset, for instance, a piece of a machinery or equipment. A subsystem of an asset may be an auxiliary system connected to one or more components of the assets to perform a task in relation to performance of the components. For example, if the asset is an oil lubricated gas compressor, the components may be bearings, seals and the like, or subsystems such as lubrication oil subsystem, dry gas seal or wet seal subsystem. The lubrication oil subsystem may be designed to supply clean lubricated oil at the correct temperature and pressure to all bearings and seals. The components and subsystems of the asset may be identified during a process of failure mode effect analysis (FMEA) that may be carried out to anticipate failure at a design stage of the asset by identifying all of the possible failures in a design or manufacturing process.

A process control system 108 may be implemented to control the industrial process of the industrial facility 102. The process control system 108 controls the assets 104-1, 104-2, . . . , and 104-n, such that the industrial process is performed in accordance with a standard operating procedure (SOP) to accomplish the predefined task. To control the assets 104-1, 104-2, . . . , and 104-n, or the components or subsystems of the assets, the process control system 108 may control values for operating parameters of one or more components and subsystems of each asset. Operating parameters of an asset 104-1, 104-2, . . . , and 104-n, or a component or a subsystem of the asset may be understood as attributes of the asset or the component or the subsystem that may be controlled or measured. Examples of operating parameters may include operational state, such as an ‘off’ or ‘on’ state of a component as well as variable parameters, such as temperature and pressure associated with various components or subsystems of the asset, that may be sensed, for example, by a corresponding sensor. Operating parameters may comprise, for example, process, mechanical and electrical parameters that may be controlled during operation of the asset, or component or subsystem of the asset.

The process control system 108 may be any computing device, such as a server, a desktop computer, laptop, smartphones, or a tablet. The process control system 108 may comprise one or more processors for executing instructions to control and monitor the operating parameters of the assets 104-1, 104-2, . . . , and 104-n, or the components or subsystems of the assets. In an example, the processor may be implemented as microprocessors, microcomputers, microcontrollers, digital signal processors, central processing units, state machines, logic circuitries, and/or any devices that manipulate signals based on operational instructions. The process control system 108 may comprise a memory for storing the instructions executable by the one or more processor. The memory may include any computer-readable medium known in the art including, for example, volatile memory (e.g., RAM), and/or non-volatile memory (e.g., EPROM, flash memory, etc.). The memory may also be an external memory unit, such as a flash drive, a compact disk drive, an external hard disk drive, or the like. The instructions may cause the processor to control and monitor the operating parameters of the assets 104-1, 104-2, . . . , and 104-n.

The operating parameters of the assets 104-1, 104-2, . . . , and 104-n may be controlled based on the SOPs. A range of values may be defined for each of the operating parameters of a component or subsystem in the SOP. The range of values defined in the SOPs may be obtained from historic data pertaining to the operating parameters, for example, based on historic data of normal operation of the industrial facility 102 to carry out the industrial process. In other examples, the range of values for each of the operating parameters may be defined by experts or by the process control system 108 based on predictive analysis of the historic data. The range of values may be confined within a predefined minimum and maximum bounds. In some cases, instead of range of values comprising the minimum bound and maximum bound being defined for each of the operating parameters of the components or the subsystems, a mean value may be defined, for example, by the expert, based on the historic data. The mean value may be used to determine the minimum and maximum bounds of normal operation behavior of the asset.

In an example, normal operational behavior of the asset 104-1, 104-2, . . . , and 104-n may be defined as behavior exhibited by the asset when the asset, or, each of the components and subsystems 106-11, 106-12, . . . , and 106-1n of the asset 104-1, as the case may be, performs as per SOPs.

Operating parameters of an asset 104-1, 104-2, . . . , and 104-n or a component or subsystem of the asset, as discussed above, are variable and may be controlled or measured. One or more sensors may be connected with the respective components or the subsystems to sense the operating parameters associated with the corresponding component or the subsystems. For example, sensors 110-11, 110-12, . . . , and 110-1n may be connected with the components or subsystems 106-11, 106-12, . . . , and 106-1n, respectively, of the asset 104-1 and the sensors 110-21, 110-22, . . . , and 110-2n may be connected with the components or the subsystems 106-21, 106-22, . . . , and 106-2n, respectively, of the asset 104-2. To control the assets 104-1, 104-2, . . . , and 104-n, or components or subsystems of the assets, the process control system 108 may alter values for operating parameters of one or more components or subsystems 106-11, 106-12, . . . , and 106-1n of each asset. To alter the values of operating parameters of a component or a subsystem of an asset, the process control system 108 may implement one or more actuators that may be connected to each component or subsystem of the assets to operate the respective component or subsystem, or to execute physical change (e.g., opening valves, switching on or off, etc.) in the respective component or the subsystem based on the commands of the process control system 108. As depicted in the example embodiment of FIG. 1, actuators 112-11, 112-12, . . . , and 112-1n may be connected with the components and the subsystems 106-11, 106-12, . . . , and 106-1n, respectively, of the asset 104-1 and the actuators 112-21, 112-22, . . . , and 112-2n may be connected with the components and the subsystems 106-21, 106-22, . . . , and 106-2n, respectively, of the asset 104-2. To control the assets, or components or the subsystems of the assets, the process control system 108 may alter values for operating parameters by sending commands to the corresponding actuator connected to the asset, or component or subsystem.

To ensure adherence with the SOP, the operating parameters may be monitored as the industrial process progresses to enable corrective action in case any of the operating parameters indicate deviation from the SOP. The process control system 108 may use the data from the sensors such as the sensors 110-11, 110-12, . . . , and 110-1n associated with the components or the subsystems 106-11, 106-12, . . . , and 106-1n, respectively, of the asset 104-1, which represent value of corresponding operating parameters to monitor the industrial process. In some cases, the process control system 108 may sense an operating parameter of a component or a subsystem of an asset independent of a sensor. For instance, the process control system 108 may directly determine an ‘off’ or ‘on’ state of a component coupled to the process control system. Also, in some situations, one or more operating parameters may be provided to the process control system 108 as manual inputs. For instance, an ‘off’ or ‘on’ state of an asset, or a component or subsystem of an asset, such as a manually operable value may be input to the process control system 108 by an operator.

In accordance with an example embodiment of the present subject matter, a system 114 may be implemented to manage performance of the assets 104-1, 104-2, . . . , and 104-n installed in the industrial facility 102. As described, the process control system 108 controls and alters the operating parameters of the assets 104-1, 104-2, . . . , and 104-n, or the components and subsystems of the asset in accordance with SOPs. As the industrial process progresses over a course of time, there may be instances where optimization of the industrial process may be required. For instance, overall monitoring and optimization of health and performance of the assets 104-1, 104-2, . . . , and 104-n may be required to determine if a design change or a maintenance activity for a particular asset is needed. The system 114 may provide such functionality, for example, by reducing the likelihood of asset failures, decreasing unplanned downtime and minimizing maintenance costs.

The system 114 may be any computing device, such as a server, a desktop computer, or a laptop. The system 114 may comprise one or more processors for executing instructions to manage performance of the asset. The system 114 may comprise one or more processors for executing instructions to monitor and manage performance of the assets 104-1, 104-2, . . . , and 104-n. In an example, the processor may be implemented as microprocessors, microcomputers, microcontrollers, digital signal processors, central processing units, state machines, logic circuitries, and/or any devices that manipulate signals based on operational instructions. The system 114 may comprise a memory for storing the instructions executable by the one or more processor. The memory may include any computer-readable medium known in the art including, for example, volatile memory (e.g., RAM), and/or non-volatile memory (e.g., EPROM, flash memory, etc.). The memory may also be an external memory unit, such as a flash drive, a compact disk drive, an external hard disk drive, or the like. The instructions may cause the processor to monitor and manage performance of the assets 104-1, 104-2, . . . , and 104-n.

The system 114 may be connected to the process control system 108 via a network 116 to monitor and manage the performance of the assets 104-1, 104-2, . . . , and 104-n. In an example, the network 116 may be a single network or a combination of multiple networks and may use a variety of different communication protocols. The network 116 may be a wireless or a wired network, or a combination thereof. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NON), Public Switched Telephone Network (PSTN). Depending on the technology, the network 116 includes various network entities, such as, gateways, routers; however, such details have been omitted for sake of brevity of the present description.

In an example, the functionality of the system 114 may be implemented in an existing asset performance management (APM) system (not shown in Figure) of the industrial facility 102 that may be implemented in or connected via the network 116 to the process control system 108 to manage, monitor and predict the health and performance of the assets.

As the industrial process progresses, a component or a subsystem of an asset or the asset installed in the industrial facility 102, may experience a deviation in one or more of its operating parameters with respect to the corresponding range of values that is predefined. In an example, the deviation may be defined as a measure of the digression of a current value of the operating parameter from a mean value in the corresponding predefined range of the values. The deviation in value of an operating parameter may be understood as a symptom of a fault in the component or the subsystem. A fault may be understood as an anomaly in a component or a subsystem of an asset or the asset. Each fault may have one or more associated symptoms. Also, every component or subsystem of an asset may have one or more associated faults. For example, lubrication oil subsystem of the oil lubricated gas compressor may have faults, such as loss of pressure, loss of lube oil quality, control oil filter anomaly and the like.

In accordance with an example embodiment of the present subject matter, faults and symptoms of each fault may be stored in the system 114 for every component and subsystem of an asset 104-1, 104-2, . . . , and 104-n. Faults and the symptoms of each fault may be identified based on historic data related to operational behavior of the asset deviating from the normal operation behavior and knowledge of the subject matter experts during the FMEA.

In accordance with an example embodiment of the present subject matter, the system 114 is configured to identify symptoms associated with each fault of a component or a subsystem. To identify symptoms of a fault, the system 114 monitors the respective operating parameters of the component or the subsystem. To monitor the operating parameters of the component or the subsystem, the system 114 may obtain the data related to current values of the operating parameters of the component or the subsystem as sensed by the corresponding sensors from the process control system 108. In another example, the system 114 may directly communicate with the sensors to obtain the data related to current values of the operating parameters. The system 114 may identify a symptom of a fault based on deviation in values of an operating parameter deviating from a mean value of the corresponding predefined range of the values. Based on an amount of the deviation from the mean value, the system 114 may be configured to assign a severity index to the symptom of the fault. The system 114 may also be configured to generate a fault alert along with a severity indicator of the fault associated with the component or the subsystem based on integrating the severity indexes of one or more identified symptoms of the fault using data fusion techniques. In an example, the data fusion techniques may assign different weightages to each symptom of a fault. For example, if a symptom contributes to X proportion of the severity of the fault, two symptoms may not correspond to 2X and rather contribute more or less than 2X.

Based on the severity of the fault, a corrective action such as scheduling a maintenance operation or changing an operating mode may be implemented. The maintenance operation may be conducted in an online or offline manner. An asset 104-1, 104-2 . . . , and 104-n involved in carrying out the industrial process may be operated in different modes of operation such as a normal operating mode wherein the process is performing intended functions, a shutdown mode or a standby mode. In an example, a HVAC system may be operated in various modes, for example, a night-mode, a day-mode or a standby mode. Thus, based on the severity of the fault operating mode of the asset, or a component or subsystem of the asset may be changed, for example, from a normal operating mode to a standby mode. Since the fault alerts are generated based on amount of deviation in values of operating parameters of the component, a reliable and accurate indication of health of the component or the subsystem of the asset may be provided which enables to predict a requirement of a maintenance operation to be carried out on the asset of the component or the subsystem of the asset in advance.

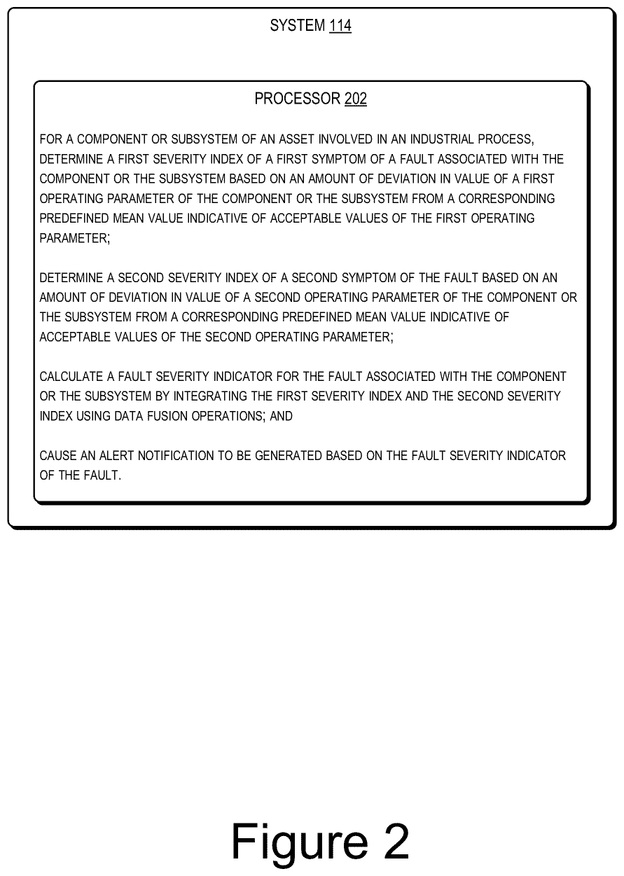

FIG. 2 shows the system 114 for managing performance of assets involved in an industrial process, according to an example implementation of the present subject matter. In an example, the system 114 monitors and manages health and performance of one or more assets 104-1, 104-2, . . . , and 104-n involved in an industrial process such that likelihood of asset failures and maintenance costs are reduced.

The system 114 may be one or more computing devices, such as desktop computers, laptops, smartphones, personal digital assistants (PDAs), tablets and servers. In an example, the system 114 may comprise a processor 202. In an example, the processor 202 may be implemented as microprocessors, microcomputers, microcontrollers, digital signal processors, central processing units, state machines, logic circuitries, and/or any devices that manipulate signals based on operational instructions.

As explained previously with reference to FIG. 1, one or more assets 104-1, 104-2, . . . , and 104-n may be installed in an industrial facility, such as the industrial facility 102 to carry out the industrial process. Each of the assets 104-1, 104-2, . . . , and 104-n may comprise one or more components or subsystems such as the components or subsystems 106-11, 106-12, . . . , and 106-1n, wherein a component of an asset may include a tool or a piece of an equipment. While a subsystem of the asset may be designed to aid in operation of one or more components of the asset. One or more sensors may be connected to each component and subsystem of an asset in the industrial facility 102, such as the sensors 110-11, 110-12, . . . , and 110-1n connected to the components or subsystems 106-11, 106-12, . . . , and 106-1n of the asset 104-1, to monitor operating parameters of corresponding component of the asset 104-1. To manage performance of the assets 104-1, 104-2, . . . , and 104-n involved in the industrial process, the system 114 may receive data related to operating parameters of each component and subsystem of the assets 104-1, 104-2, . . . , and 104-n as sensed by the sensors from the process control system 108 installed in the industrial facility 102 to control the industrial process or directly from the corresponding sensors, as described above. Based on the data related to operating parameters of a component of an asset 104-1, 104-2, . . . , and 104-n, the system 114 may identify symptoms of each of the one or more faults associated with the component or the subsystem. A symptom of a fault may be identified based on a deviation in value of an operating parameter from a corresponding predefined mean value indicative of acceptable values of the respective operating parameter. In an example, a percentage of deviation from the mean value may be predefined for each operating parameter of a component or subsystem to indicate a range of acceptable values of the respective operating parameter.

In an example implementation, for a component or a subsystem of an asset, such as the component or subsystem 106-11 of the asset 104-1, the system 114 may determine a first severity index of a first symptom of a fault associated with the component or subsystem 106-11 based on an amount of deviation in value of a first operating parameter of the component or subsystem 106-11 from a corresponding predefined mean value indicative of acceptable values of the first operating parameter. The system 114 may similarly determine a second severity index of a second symptom of the fault based on an amount of deviation in value of a second operating parameter of the component 106-11 from a corresponding predefined mean value indicative of acceptable values of the second operating parameter. The severity index of a symptom indicates the level of severity of the symptom of the fault. In an example, the first and second severity indexes may be determined to be within a normalized range, such as 0-1, 0-10, 0-100 or 0-1000.

In an example implementation, the system 114 may calculate a fault severity indicator for the fault associated with the component or the subsystem 106-11 by integrating the first severity index and the second severity index using data fusion operations. In an example, the data fusion operations may be based on fuzzy based fusion, Bayesian based fusion, Dempster Shafer fusion. Based on the fault severity indicator of the fault, the system may generate an alert notification. In an example, a threshold value may be predefined for fault severity indicator of each fault associated with the component or the subsystem 106-11. In the event of a fault severity indicator of a fault exceeding corresponding threshold value, an alert notification may be generated by the system 114 to notify an operator, for example, in a control room of the industrial facility 102.

The system 114 aids in not only alerting stakeholders in relation to faults or failures in an asset 104-1, 104-2, . . . , and 104-n. or components or subsystems of the asset in the industrial facility 102, but also provides for evaluating and prioritizing maintenance or replacement operations for the assets 104-1, 104-2, . . . , and 104-n or their components and subsystems by accurate estimation of level of severity of fault or failure in the asset 104-1, 104-2, . . . , and 104-n or its components and subsystems based on its use of data fusion operations. This allows for efficient resource allocation, maintenance schedules, and risk management strategies.

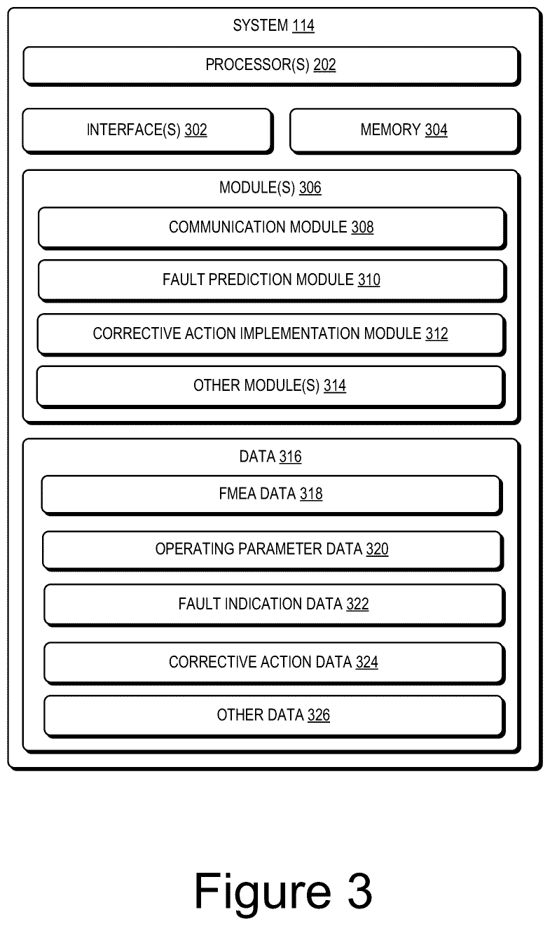

FIG. 3 illustrates the system 114 according to another example implementation of the present subject matter. In an example, the system 114 may be any computing device, such as servers, desktop computers, laptops, smartphones, personal digital assistants (PDAs), and tablets.

In an example, the system 114 comprises a processor, such as the above-described processor 202. In an example, the processor 202 may be implemented as microprocessors, microcomputers, microcontrollers, digital signal processors, central processing units, state machines, logic circuitries, and/or any devices that manipulate signals based on operational instructions. The system 114 also comprise interface(s) 302 coupled to the processor 202. The interface(s) 302 may include a variety of software and hardware interfaces that allow interaction of the system 114 with other communication and computing devices, such as network entities, web servers, and external repositories, and peripheral devices. For example, the interface(s) 302 may couple the system 114 with the process control system 108. The interface(s) 302 may also enable coupling of internal components of the system 114 with each other.

Further, the system 114 comprises a memory 304 coupled to the processor 202. The memory 304 may include any computer-readable medium known in the art including, for example, volatile memory (e.g., RAM), and/or non-volatile memory (e.g., EPROM, flash memory, etc.). The memory may also be an external memory unit, such as a flash drive, a compact disk drive, an external hard disk drive, or the like. The system 114 may comprise module(s) 306 and data 316 coupled to the processor 202. In one example, the module(s) 306 and the data 316 may reside in the memory 304.

In an example, the data 316 may comprise a FMEA data 318, operating parameter data 320, fault indication data 322, corrective action data 324, and other data 326. The module(s) 306 may include routines, programs, objects, components, data structures, and the like, which perform particular tasks or implement particular abstract data types. The module(s) 306 further includes modules that supplement applications on the system 114, for example, modules of an operating system. The data 316 serves, amongst other things, as a repository for storing data that may be fetched, processed, received, or generated by one or more of the module(s) 306. The module(s) 306 may include a communication module 308, a fault prediction module 310, a corrective action implementation module 312 and other module(s) 314. The other module(s) 314 may include programs or coded instructions that supplement applications and functions, for example, programs in the operating system of the system 114.

As explained previously with reference to FIG. 1, the system 114 manages performance of assets involved in an industrial process. Industrial process may involve chemical, electrical or mechanical procedures for a predefined purpose, for instance, to manufacture an item or provide air conditioning or generate fire alerts. The industrial process may be carried out in industrial facilities, an example of which has been discussed in reference to FIG. 1. A series of assets, such as the assets 104-1, 104-2 . . . , and 104-n may be installed in the industrial facility 102 to carry out the industrial process. Each asset 104-1, 104-2 . . . , and 104-n may comprise one or more components and subsystems, such as 106-11, 106-12, . . . , and 106-1n of the asset 104-1 and each component of an asset may be a piece of an equipment or machinery. For example, an HVAC system may comprise multiple components, such as chiller, boiler, heat exchangers, pumps operating in conjunction with each other to air condition a premises. A subsystem of an asset may be distinct unit within the asset that performs a specific function or set of functions necessary for the overall operation of the asset or one or more components of the asset. The subsystem may be connected to one or more components of the asset to perform functions necessary for the operation of these components. Each subsystem may be composed of various components that work together to perform a particular task, and these subsystems collectively contribute to the asset's overall functionality and efficiency. In an example, the constituting components of the subsystem and the components to which the subsystem is connected may be a subset of the one or more components of the asset. In another example, the components of the subsystem may be external to the asset. For instance, a power supply subsystem may comprise components such as generators, batteries, voltage regulators, power distribution units to provide and manage electrical power to various parts or components of an asset. In another example, a steam turbine may be an asset in an industrial facility for applications, such as driving generators or compressors. The steam turbine may comprise components, such as bearings and seals and subsystems such as lubricating oil subsystem, seal subsystem. For smooth operation and to support the rotating components various types of bearings are used in a steam turbine. Seal subsystem may be used to reduce the leakage of steam between rotary and stationary parts of the steam turbine. In a steam turbine, lubricating oil subsystem may be used to supply clean lubricated oil at required temperature and pressure to bearings, control equipment and seals. Lube oil subsystems may comprise components such as lube oil pumps, heat exchangers, valves and tanks. While seal subsystems include various valves and supply lines such as nitrogen supply line, filters at these lines and valves.

In a given industrial process, each component or subsystem, such as the component 106-11 or subsystem of the asset 104-1 may be operated in accordance with predefined operating parameters. As mentioned above, the operating parameters of a component or subsystem may be understood as operational state of the component or subsystem such as ‘on’ or ‘off’ state and other variable parameters comprising process, mechanical and electrical parameters that may be controlled or measured during operation of the asset, or component or subsystem of the asset, such as pressure, temperature, air flow and humidity in case of a component of the HVAC system. Referring to the above example of the HVAC system implemented to air condition a premises, the components, i.e., the chillers, boiler, heat exchangers, pumps may be operated in accordance with predefined operating parameters as dictated by SOPs, which take into account various factors, such as the temperature to be maintained in the premises, ambient temperature, humidity etc. In an example, operating parameters of the subsystems may be the operating parameters of its constituting components.

Thus, the operating parameters of the components and subsystems of each asset, such as the components and subsystems 106-11, 106-12, . . . , and 106-1n of the asset 104-1 may be controlled as per SOPs of the industrial process and measured, for example, using the sensors 110-11, 110-12, . . . , and 110-1n coupled to the components and subsystems 106-11, 106-12, . . . , and 106-1n, respectively. In an example implementation, the process control system 108 may monitor and control operation of the asset 104-1, 104-2, . . . , and 104-n installed in the industrial facility 102 for compliance of SOPs of the industrial process carried out in the industrial facility 102. To monitor the operation of an asset 104-1, 104-2, . . . , and 104-n, the process control system 108 may receive the values of operating parameters of components and subsystems of the asset 104-1, 104-2, . . . , and 104-n from the sensors or directly from the components and subsystems. The SOPs also define a range of values for each operating parameter of components and subsystems of an asset 104-1, 104-2, . . . , and 104-n.

The range of values may be defined based on a historic data related to operation of the asset 104-1, 104-2, . . . , and 104-n when the asset exhibited normal operational behavior during the industrial process. When the asset 104-1, 104-2, . . . , and 104-n or each component and subsystem of the asset 104-1, 104-2, . . . , and 104-n exhibits the expected behavior as defined in the SOPs, the asset 104-1, 104-2, . . . , and 104-n is said to exhibit a normal operational behavior, or simply, a normal behavior. In an example, the process control system 108 or the subject matter experts may define the range of values for operating parameters based on the historic data. In an example, a range of values for an operating parameter may be defined as a pair of values corresponding to minimum and maximum bound. In another example, single value, termed as a mean value may be defined and maximum and minimum bounds may be determined using the mean value. For example, a percentage may be defined to indicate maximum and minimum bounds around the mean value, such as 10% on either side of the mean value. In such a case, the range of values may include values deviating from the mean value up to the specified percentage. In an example, the predefined mean values may be periodically updated based on historical data and changing operational conditions to ensure they accurately represent the normal operational behavior of the component or subsystem. This adaptive approach may help in maintaining the effectiveness of the system over time, even as the asset's characteristics evolve due to factors such as wear, environmental conditions, or operational changes.

In an example, a threshold limit may also be defined for each operating parameter to indicate a risk to the safety of the asset or a value beyond which the asset 104-1, 104-2, . . . , and 104-n, or the component or subsystem such as 106-11 of the asset 104-1 may not work. Working of the asset 104-1, 104-2, . . . , and 104-n, or the component or subsystem of the asset at or beyond the threshold limit may cause damage to the asset. The threshold limit may comprise a maximum threshold and a minimum threshold. The threshold limit for the operating parameters of the component or subsystem 106-11 of the asset 104-1 may be defined, for example, by a manufacturer of the asset based on various factors, such as rated capacity, design, and other factors relating to the performance capability of the asset to prevent malfunctions or damage to the asset during its installation and operation in the industrial facility 102. In an example, the threshold limit may also be defined in terms of a percentage from the mean value.

The process control system 108 may process the data collected by the sensors 110-11, 110-12, . . . , and 110-1n to make decisions regarding values of operating parameters of the components and subsystems of the asset connected with the sensors. To control the asset 104-1, 104-2, . . . , and 104-n, the process control system 108 may then send commands to a corresponding actuator connected to the asset, such as the actuators 112-11, 112-12, . . . , and 112-1n connected with the components and subsystems 106-11, 106-12, . . . , and 106-1n, respectively, of the asset 104-2, or the component or subsystem to alter values for operating parameters accordingly. During operation of the industrial process, failure of a component or subsystem of an asset 104-1, 104-2, . . . , and 104-n or the asset may result in an unplanned maintenance operation to be performed on the component or subsystem, or the asset 104-1, 104-2, . . . , and 104-n. This in turn, affects the operation of the industrial process. Thus, the health or performance of the assets 104-1, 104-2, . . . , and 104-n needs to be monitored and managed for the optimization of industrial process. The system 114 works in conjunction with the process control system 108 to monitor and manage the health and performance of the assets 104-1, 104-2, . . . , and 104-n in the industrial facility 102. To monitor the performance of an asset 104-1, 104-2, . . . , and 104-n, the system 114 monitors the operating parameters of each component and subsystem of the asset 104-1, 104-2, . . . , and 104-n.

In an ongoing industrial process, a component or a subsystem of an asset, such as the component or subsystem 106-11 of the asset 104-1 or the asset, may experience a deviation in one or more of its operating parameters with respect to the corresponding range of values that is predefined. For example, consider a pipeline installed in an industrial facility that is being monitored for temperature as one of its operating parameters. A range of the temperature for normal operational behavior of the pipeline may be predefined to be between 70° C. and 90° C. If the temperature sensor connected to the pipeline detects a value that falls outside of this range, such as 95° C., this would constitute a deviation.

Deviation in values of an operating parameter from corresponding predefined range of values may be considered as a symptom of a fault that may be associated with the component or subsystem. One or more faults may be associated with a component or subsystem 106-11 of an asset 104-1 and each fault may have one or more associated symptoms. For example, an oil lubricated gas compressor may comprise components, such as bearings and subsystems such as lubrication oil subsystem and seal subsystem. Bearings may have associated faults, such as a fault in a drive end bearing or non-drive end bearing, referred to as drive end bearing fault or non-drive end bearing fault, respectively. The faults in the bearings may have symptoms, such as vibrations in the bearings. The drive end bearing fault may have symptoms, such as drive end bearing vibration along X axis and drive end bearing vibration along Y axis. Similarly, the non-drive end bearing fault may have symptoms, such as non-drive end bearing vibration along X axis and non-drive end bearing vibration along Y axis. Further, the lubrication oil subsystem may have faults that may occur in lubrication oil subsystem because of anomalous temperature and pressure in the lube oil header, referred to as lube oil header temperature fault or lube oil pressure fault, respectively. The lube oil header temperature fault may be identified based on a symptom of anomalous temperature of header of the lubrication oil subsystem. Likewise, a lube oil header pressure fault may be identified based on a symptom indicative of abnormal pressure in the lube oil header. Similarly, seal subsystem may have fault associated with a seal which may have symptoms, such as anomalies in gas flow rate at drive end primary vent and gas flow rate at non-drive end primary vent.

In an example, the fault associated with each component or subsystem of an asset such as the components and subsystems 106-11, 106-12, . . . , and 106-1n of the asset 104-1 and symptoms associated with each fault may be identified through a failure mode effect analysis (FMEA). The FMEA is a process performed during the design stage of an asset or an industrial process to identify potential failures that might occur within the design of the asset or the process, discover effects of those failures and recommend actions to be taken to deal with the failures. In an example, FMEA may be performed, for example, by the process control system 108 for the asset 104-1, 104-2, . . . , and 104-n based on historic data related to real time operation of similar asset using predictive analysis and other statistical approaches and subject matter experts.

In an example, data related to faults associated with the components and subsystems 106-11, 106-12, . . . , and 106-1n of the asset 104-1 involved in the industrial process and symptoms associated with each fault may be provided to the system 114 by the process control system 108 or in one example, the system 114 may carry out the FMEA analysis for the asset. The communication module 308 of the system 114 may receive these data which may be stored in the FMEA data 318 of the system 114. In another example, data related to faults and symptoms for each component ad subsystem of every asset may be stored in the FMEA data 318 of the system 114 manually by a user through a graphical user interface.

In an example embodiment of the present subject matter, the fault prediction module 310 of the system 114 is configured to identify symptoms associated with each fault of a component or subsystem 106-11 of an asset 104-1. To identify the symptoms of a fault, the fault prediction module 310 may monitor operating parameters of the component or subsystem 106-11. In an example, to enable the fault prediction module 310 to monitor operating parameters of the component or subsystem 106-11, the communication module 308 of the system 114 may receive data related to current values of operating parameters of the component or subsystems 106-11 as sensed by the corresponding sensors 110-11 from the process control system 108, for instance, over the network 116. In another example, the communication module 308 may directly receive data related to operating parameters of the component or subsystem 106-11 from the corresponding sensors 110-11. The data related to current values of operating parameters of the component or subsystem 106-11 may be stored in the operating parameter data 320 of the system 114. The communication module 308 may also obtain predefined range of values for each operating parameter of the component or subsystem 106-11 from the process control system 108 and the predefined range of values may be stored in the operating parameter data 320 of the system 114. Based on the monitoring, the fault prediction module 310 may identify one or more operating parameters of the component or subsystem 106-11 to deviate from corresponding predefined range of values. As mentioned above, deviation in an operating parameter indicates a symptom of a fault.

In case of above example of oil lubricated gas compressor, a mean value and a threshold limit for operating parameters corresponding to symptoms of drive end bearing fault, i.e., drive end bearing vibration along X axis and drive end bearing vibration along Y axis may be predefined in corresponding range of values as 20 and 60, respectively. A mean value for operating parameters corresponding to symptoms of non-drive end bearing fault of bearings, i.e., non-drive end bearing vibration along X axis and non-drive end bearing vibration along Y axis may be predefined in corresponding range of values as 32 and 22, respectively, while the threshold limit for these operating parameters may be defined as 60. The current values as sensed by the respective sensors for drive end bearing vibration along X axis, drive end bearing vibration along Y axis, non-drive end bearing vibration along X axis and non-drive end bearing vibration along Y axis may be 24, 48, 36 and 50, respectively. The current value, corresponding mean value and threshold limit for parameter lube oil header temperature corresponding to symptom of lube oil header temperature fault of lube oil subsystem may be 48, 48 and 65, respectively. Similarly, the current value, corresponding mean value, and threshold limit for parameter lube oil header pressure corresponding to symptom of lube oil header pressure fault of lube oil subsystem may be 1.19, 1.5 and 1.1, respectively. Further, the current value, corresponding mean value, and threshold limit for each of the parameters drive end primary vent gas flow and non-drive end primary vent gas flow corresponding to symptoms of a seal fault may be 4, 5 and 25, respectively. Thus, except for the symptom of lube oil header temperature of lube oil header temperature fault of lube oil subsystem, each operating parameter corresponding to symptoms of every fault of components bearing subsystem, lube oil subsystem and seal subsystem may be identified to have deviated from the corresponding mean value.

In an example, the fault prediction module 310 may determine an amount of the deviation in the respective operating parameters from the corresponding predefined range of values. In the above example of oil lubricated gas compressor, the amount of deviation in operating parameters, namely, drive end bearing vibration along X axis, drive end bearing vibration along Y axis, non-drive end bearing vibration along X axis, non-drive end bearing vibration along Y axis may be determined as 4, 28, 4, 28, respectively. Likewise, deviation in lube oil header temperature, lube oil header pressure, drive end primary vent gas flow, and non-drive end primary vent gas flow from the corresponding mean values may be determined as 0, 0.31, 1 and 1, respectively. In some cases, the extent of deviation from the mean value may be used to assess the severity or progression of a potential fault. Small deviations might indicate early stages of degradation or minor issues, while larger deviations could suggest more serious problems requiring immediate attention. Additionally, the relationship between multiple operating parameters may be analyzed. In some instances, a fault might manifest as deviations in several related parameters simultaneously, providing a more comprehensive picture of the component's condition.

In an example embodiment of the present subject matter, the fault prediction module 310 may assign a severity index to each of one or more symptoms of a fault based on the amount of the deviation in the respective operating parameters from the corresponding predefined range of values. For instance, the fault prediction module 310 may determine a first severity index of a first symptom of a fault associated with the component or subsystem 106-11 based on an amount of deviation in value of a first operating parameter of the component or subsystem 106-11 from a corresponding predefined mean value indicative of acceptable values of the first operating parameter. The fault prediction module 310 may further determine a second severity index of a second symptom of the fault based on an amount of deviation in value of a second operating parameter of the component or subsystem 106-11 from a corresponding predefined mean value indicative of acceptable values of the second operating parameter. In an example, to assign the severity index to a symptom of the fault, the severity index may be conformed to a normalized range based on the amount of deviation in the respective operating parameter from a mean of the corresponding predefined range of values. In an example, the normalized range may be 0-1, 0-10, 0-100 or 0-1000. In an example, the severity index may be assigned to a symptom by conforming the amount of deviation from the corresponding mean value to a normalized range such as 0-1, 0-10, 0-100 or 0-1000. The severity index may be calculated using various methods, such as linear scaling, logarithmic scaling, or custom scaling functions. For instance, a linear scaling method may map the minimum deviation to the lower end of the chosen range and the maximum deviation to the upper end, with intermediate deviations scaled proportionally. Alternatively, a logarithmic scale may be employed to emphasize smaller deviations while compressing larger ones. The choice of normalization range and scaling method may depend on the specific requirements of the system 114 and the nature of the industrial process being monitored. In one example, the normalized value may be calculated by the below equation, but not limited to this calculation only:

$$Normalized Value = \frac{Measured Value - Mean Vlaue}{Maxiumum or Minimum threshold - Mean Value} \qquad Equation 1$$

Referring again to the above example, the amount of deviation in the operating parameters of drive end bearing vibration along X axis and drive end bearing vibration along Y axis from corresponding mean value of 20, i.e., 28 may be conformed to values of 0.09 and 0.69, respectively, in a normalized range of 0-1.

While conforming the deviation to the normalized value, the amount of deviation beyond the threshold value or limit may be conformed to highest value in the normalized range, for example, 1 in the normalized range of 0-1. The severity index of a symptom indicates the severity of the symptom for the respective fault, for example, higher severity index indicates that the symptom of the fault is severe. In an example, the severity indexes of each symptom of the fault may be stored in the fault indication data 322 of the system.

In an example embodiment of the present subject matter, having assigned the severity index to each symptom of a fault, the fault prediction module 310 may calculate or determine, a fault severity indicator for the fault associated with the component or subsystem 106-11 based on severity indexes of the each of the one or more symptoms of the fault. For instance, the fault prediction module 310 may calculate a fault severity indicator for the fault associated with the component or subsystem 106-11 by integrating the first severity index and the second severity index using data fusion operations. In an example, to determine the fault severity indicator for the fault associated with the component or subsystem 106-11, the fault prediction module 310 may calculate a weight of the fault based on a predefined value indicative of an impact of the fault on the corresponding component or subsystem 106-11 of the asset 104-1, a count of the one or more symptoms of the fault and the severity indexes of the one or more symptoms of the fault. Thus, a weight of a fault associated with a component or subsystem 106-11 may be understood as a weightage assigned to the fault in relation to other faults associated with the component or subsystem 106-11. Some faults associated with a component or subsystem 106-11 of an asset 104-1 may have a more severe impact on the operation of the component or subsystem, or the asset in comparison to other faults associated with the component or subsystem 106-11. Thus, a value, also termed as an impact parameter, indicative of the impact of the fault on the operation of the corresponding component or subsystem 106-11 of the asset 104-1 may be predefined for each fault associated with the component or subsystem 106-11. The impact parameter may be defined based on loss of production to be accrued upon the asset 104-1 being rendered non-operation owing to the fault in the component or subsystem 106-11.

The loss of production may be estimated from the historic data related to past operation of the similar asset or knowledge of the subject matter experts. In an example, the estimation process may involve analyzing historical data from comparable assets to predict potential production losses. Factors considered in this calculation may include downtime duration, production rate, product value, and any associated costs such as emergency repairs or replacement parts. In some cases, the impact parameter may also account for indirect losses, such as missed deadlines, customer dissatisfaction, or potential contract penalties. The accuracy of this impact parameter may be refined over time as more data becomes available, allowing for more precise predictions of the economic consequences of faults. The impact parameters of each fault may be defined during the process of FMEA when the faults are identified, for example, by the system 114 or by the process control system 108. If defined by the process control system 108, the impact parameter may be provided to the system 114 by the process control system 108. The communication module 308 of the system 114 may obtain such data which may be stored along with the fault in the FMEA data 318 of the system 114.

Further, severity of a fault of a component or subsystem 106-11 may also be affected by number of symptoms of the fault for which operating parameters deviate from their corresponding predefined mean values and associated severity indexes of those symptoms. That is, as the severity indexes of one or more symptoms increase, the weight of the fault may also increase. Thus, the fault prediction module 310 may determine a count of symptoms of the fault associated with the component or subsystem 106-11 of the asset 104-1 involved in the industrial process based on a count of operating parameters of the component or subsystem 106-11 deviating from their corresponding predefined mean values that indicate acceptable values of the operating parameters. Having computed the weight of the fault, the fault prediction module 310 may determine the fault severity indicator of fault by integrating severity indexes of each of the one or more symptoms of the fault and the weight of the fault using a first fusion function implementing data fusion operations. The fault severity indicator may be determined in a normalized range such as 0-1, 0-10, 0-100 or 0-1000. This normalization allows for consistent comparison and interpretation of fault severity across different components or subsystems. The choice of range may depend on the desired granularity of the severity scale and the specific requirements of the monitoring system.

In an example, the first fusion function may be based on any one of fuzzy based fusion, Bayesian based fusion, Dempster Shafer fusion. These fusion methods provide different approaches to combining multiple pieces of evidence or data. Fuzzy based fusion may use fuzzy logic principles to handle imprecise or uncertain information, allowing for a more nuanced representation of fault severity. Bayesian based fusion may utilize probabilistic reasoning to update fault severity based on new evidence, incorporating prior knowledge and current observations. Dempster Shafer fusion may combine evidence from multiple sources while allowing for the representation of ignorance or conflicting information in the severity assessment. The choice of fusion method may depend on factors such as the nature of the available data, the desired handling of uncertainty, and the computational resources available in the system 114. In an example, if fuzzy based fusion is used to determine fault severity indicator, a fuzzy membership function based on fuzzy operations such as fuzzy AND, fuzzy OR and fuzzy NOT may integrate the severity indexes of the symptoms and the weight of the fault to produce the fault severity in the normalized range, such as 0-1.

In an example, the fault prediction module 310 may calculate the fault severity indicator for each of one or more faults associated with the component or subsystem 106-11 based on severity indexes of symptoms of the corresponding fault associated with the component or subsystem 106-11. In an example, the fault severity indicator of each fault associated with the component or subsystem 106-11 may be stored in the fault prediction data 310 of the system 114. In case of above example of compressor, fault severity indicator of the fault, namely, drive end bearing fault, associated with the component bearings may be determined as 0.41 by integrating severity indexes of symptoms drive end bearing vibration along X axis and drive end bearing vibration along Y axis. Similarly, fault severity indicator of the fault, non-drive end bearing fault, associated with the component bearing subsystem may be determined as 0.53 by integrating severity indexes of symptoms non-drive end bearing vibration along X axis and non-drive end bearing vibration along Y axis. Fault severity indicators for the lube oil header temperature fault and the lube oil pressure fault may be determined as 0.15 and 0.705, respectively, based on the severity indexes of symptoms lube oil header temperature and lube oil header pressure. While fault severity indicator of seal fault associated with seal subsystem may be determined as 0.175077 by integrating severity indexes of symptoms drive end primary vent gas flow and non-drive end primary vent gas flow.

In an example embodiment, the corrective action implementation module 312 may cause a corrective action when the fault severity indicator is above a predetermined threshold. As described, a severity index of a symptom of a fault associated with the component or subsystem 106-11 of the asset 104-1 is determined based on a deviation in respective operating parameter from a mean value of the corresponding predefined range of values indicative of normal operational behavior of the asset 104-1. The mean value may correspond to an optimal value of the operating parameter and values of the operating parameter within the minimum and maximum bound of the predefined range of values about the mean value may not contribute considerably to severity of corresponding symptom and consequently to a fault severity indicator of the associated fault. Thus, a threshold value for the fault severity indicator of the fault may be predetermined in the corresponding normalized range to indicate that below the threshold value of fault severity indicator, the fault may not require urgent attention, while corrective action needs to be taken to address the fault, if the fault severity indicator goes beyond the threshold value.

In an example implementation, the corrective action may comprise an alert notification to be generated based on the fault severity indicator of the fault. The corrective action implementation module 312 may generate the alert notification if the fault severity indicator of the fault associated with the component 106-11 goes beyond the corresponding threshold value. In the case of the above example, a threshold value for the fault severity indicator of the lube oil header temperature fault may be predefined as 0.2. When the fault severity indicator is determined as 0.15, the same does not exceed the corresponding threshold value. Thus, no alert notification may be generated. While a threshold value for the fault severity indicator of the seal fault may be predefined as 0.1 and the fault severity indicator, determined as 0.15, which goes beyond the corresponding threshold value, causes an alert notification to be generated to notify operator or service personnel regarding the severity of the fault. In an example, the corrective action implementation module 312 can be preconfigured with contact information of an operator and may send message to a registered phone no. or registered email address. In some cases, an alert notification may trigger an automated or manual response, such as opening a relief valve to mitigate an overpressure condition in a tank.

Similarly, in another example, the corrective action implementation module 312 can generate a message to be displayed in a control room of the industrial facility 102 to notify operators in the control room. The message may indicate corrective action and location of the asset 104-1 or the component or subsystem 106-11 of the asset 104-1 on which the corrective action is to be carried out, for instance. In an example, the alert notification indicating the fault along with corresponding fault severity indicator can also be displayed in real-time on screens in a control room of the industrial facility, allowing operators to monitor and respond to the faults as they occur. The corrective action implementation module 312 may also be configured to categorize the faults in accordance with the fault severity indicators in different zones and highlight them with different colors for prioritization and quick action. For instance, the corrective action implementation module 312 may display in the control room of the industrial facility, the fault severity indicator in one of plurality of zones. A zone in the plurality of zones corresponds to a predefined range of values of the fault severity indicator. This allows for real-time monitoring and intervention based on the zone of the fault, facilitating prompt and informed decision-making to maintain the normal operational behavior of the asset as defined in the SOPs.

In an example implementation of the present subject matter, once the fault severity indicators are determined for each fault from amongst one or more faults associated with the component or subsystem 106-11 of the asset 104-1, the fault prediction module 310 may also determine a component level degradation indicator or a subsystem level degradation indicator, as the case may be for the component or subsystem 106-11. To determine component level degradation indicator for a component 106-11, the fault prediction module 310 may calculate a weight of a failure of the component 106-11 based on a predefined value indicative of an impact of the failure of the component 106-11 on the asset 104-1, a number of the faults, and the fault severity indicators of each fault associated with the component 106-11. A weight of a failure of a component 106-11 of an asset 104-1 may be understood as a weightage assigned to the failure of the component 106-11 in relation to failure of other components, such as the components 106-12, . . . , 106-1n of the asset 104-1. As would be understood, failure of a component 106-11 of an asset 104-1 may have a more severe impact on the operation of the asset 104-1 in comparison to other components of the asset. For instance, failure of the component 106-11 that may cause failure of other components of the asset such as the components 106-12, . . . , 106-1n of the asset 104-1 may have a more severe impact on the operation of the asset 104-1 as it may lead to secondary damages. For example, failure or faults of lubrication subsystem may lead to failure of bearings. Thus, a value, also termed as an impact parameter, indicative of the impact of the failure of the component 106-11 on the operation of the corresponding asset 104-1, may be predefined for each component of the asset 104-1. The impact parameter may be defined based on potential loss of production that would occur if the asset were to become non-operational as a result of failure of the component. The loss of production may be estimated from the historic data or knowledge of the subject matter experts. The impact parameters of failure of each component of an asset may be defined based on the process of FMEA, for example, by the system 114 or by the process control system 108. The communication module 308 of the system 114 may obtain such data from the process control system 108 if defined by the process control system 108. Data related to impact parameters of failure of each component 106-11, 106-12, . . . , and 106-1n of an asset 104-1 may be stored in the FMEA data 318 of the system 114.

Further, severity of a component's failure can also be influenced by a cumulative effect of multiple faults over time. Even if individual faults are relatively less severe, their cumulative impact can eventually lead to a critical failure if left unaddressed. Essentially, the severity of failure of a component 106-11 of an asset 104-1 is influenced by both the number of faults it experiences and the severity of each individual fault. Thus, the fault prediction module 310 may determine a count of the faults having the fault severity indicators beyond their respective predefined threshold values. The fault prediction module 310 may determine weight of the failure of the component 106-11 based on the impact parameter indicative of impact of the failure of the component 106-11 on the asset 104-1, the count of the faults and the fault severity indicators of each fault associated with the component 106-11. This ensures, as the fault severity indicators of one or more faults increase, the weight of the fault also increases. The fault prediction module 310 may then determine the component level degradation indicator for the component 106-11 by integrating the fault severity indicators of each of the plurality of faults associated with the component 106-11 and the weight of the failure of the component using a second fusion function implementing data fusion operations. In an example, the second fusion function may be based on any one of fuzzy based fusion, Bayesian based fusion, Dempster Shafer fusion.

In a similar manner, to determine subsystem level degradation indicator for the subsystem 106-11, the fault prediction module 310 may determine weight of the failure of the subsystem 106-11 based on an impact parameter indicative of impact of a failure of the subsystem 106-11 on the asset 104-1, a count of the faults and the fault severity indicators of each fault associated with the subsystem 106-11. Further, as described above, a subsystem may be connected to one or more components of the asset to aid operation of such components. These components to which the subsystem may be connected may in turn comprise a subset of the one or more components of the assets and may be identified in FEMA. An anomaly in the subsystem may impact at least one component in the subset of components. Accordingly, the faults introduced in an impacted component may contribute to the subsystem level degradation indicator. Consequently, the component level degradation indicators of the impacted components may be indicative of faults of the subsystem and may serve as fault indicators for the subsystem. In another example, the component level degradation indicators of the impacted components may also serve as a symptom of a fault associated with the subsystem. In an example implementation, the fault prediction module 310 may determine the subsystem level degradation indicator for the subsystem 106-11 by integrating the fault severity indicators of each of the plurality of faults associated with the subsystem 106-11, the component level degradation indicators of the at least one component in the subset of components of the subsystem, and the weight of the failure of the subsystem using the second fusion function implementing data fusion operations.

In accordance with an example implementation of the present subject matter, the component level degradation indicator or the subsystem level degradation indicator may be determined in a normalized range such as 0-1, 0-10, 0-100 or 0-1000. In an example, in case of fuzzy based fusion, a fuzzy membership function based on fuzzy operations such as fuzzy AND, fuzzy OR and fuzzy NOT may integrate the fault severity indicators of each fault associated with the component or the subsystem 106-11 and the weight of the failure of the component or the subsystem to produce the component level degradation indicator or the subsystem level degradation indicator, as the case may be, in a normalized range such as 0-1. In an example, the fault prediction module 310 may calculate or determine the component level degradation indicators and subsystem level degradation indicators for each of the one or more components and subsystems 106-11, 106-12, . . . , and 106-1n of the asset 104-1 based on the fault severity indicators of the faults associated with the respective component or subsystem of the asset 104-1. In an example, the component level degradation indicators and the subsystem level degradation indicators of each component and subsystem 106-11, 106-12, . . . , and 106-1n of the asset 104-1 may be stored in the fault indication data 322 of the system. Referring to the above example of the compressor to elaborate, degradation indicator for bearings may be determined as 0.74507 by integrating the fault severity indicators of the faults drive end bearing fault and non-drive end bearing fault associated with the component bearings. Further, since faults in the lube oil subsystem, such as high value of header temperature and low value of header pressure impact the bearings, the component level degradation indicator of the bearings may be integrated along with the faults of the lube oil subsystem to determine lube oil subsystem degradation indicator. Thus, the lube oil subsystem's degradation indicator may be determined as 0.89 by integrating the fault severity indicators for the lube oil header temperature fault and the lube oil pressure fault and the component level degradation indicator of the bearings. While seal subsystem degradation indicator may be determined as 0.175077 based on the fault severity indicator of the seal fault.

In an example implementation of the present subject matter, based on the component level degradation indicators and the subsystem level degradation indicators of each of the components and subsystems 106-11, 106-12, . . . , and 106-1n of the asset 104-1, a corrective actions to be taken to address the faults or failures of the at least one of the components or the subsystem of the asset 104-1 may be recommended, prioritized and scheduled by the corrective action implementation module 312. For instance, based on the component level degradation indicators and the subsystem level degradation indicators of the components and subsystems 106-11, 106-12, . . . , or 106-1n of the asset 104-1, if a corrective action comprises carrying out a maintenance operation on the components or subsystems 106-11, 106-12, . . . , or 106-1n, the maintenance operation to be performed may be prioritized and scheduled. In an example, the recommended corrective action and schedule of maintenance operations may be stored in the corrective action data 324 of the system 114. The corrective action implementation module 312 may generate the schedule based on a variety of factors, such as a time of the day during which the asset is idle or the non-working state. For instance, for an office building, the maintenance may be scheduled after non-working hours when the assets 104-1, 104-2, . . . , and 104-n remain idle. The operator may be notified of the schedule of the maintenance operation.

In an example embodiment of the present subject matter, the fault prediction module 310 may determine an asset level degradation indicator for the asset 104-1, 104-2, . . . , and 104-n. Severity of failure of an asset 104-1, 104-2, . . . , and 104-n may be amplified if a standby or backup asset for the asset 104-1, 104-2, . . . , and 104-n is not available or under maintenance. Accordingly, the fault prediction module 310 may also receive an indication, for example, from the process control system 108 that a standby asset for the asset 104-1, 104-2, . . . , and 104-n is unavailable, for example due to being under maintenance. Further, an impact of a failure of an asset 104-1, 104-2, . . . , and 104-n in relation to other assets 104-1, 104-2, . . . , and 104-n involved in the industrial process can be significant and can vary depending on several factors. For instance, assets 104-1, 104-2, . . . , and 104-n within an industrial facility 102 often have interdependencies. The failure of one asset can trigger a chain reaction affecting other interconnected assets. For example, in a manufacturing plant, if a critical machine fails, it may disrupt the entire production line, affecting downstream processes and possibly other related assets. Some assets may be more critical than others in terms of their impact on the overall industrial process. A failure in a critical asset, such as a power generator or a core server in a data center, can have far-reaching consequences compared to the failure of a less critical asset. Accordingly, a value, also termed as impact parameter, indicative of an impact of a failure of the asset 104-1, 104-2, . . . , and 104-n on an industrial process carried out in the industrial facility 102, may be predefined the predefined impact parameter for the asset 104-1, 104-2, . . . , and 104-n. The impact parameter may be computed based on loss of production to be accrued upon the asset 104-1, 104-2, . . . , and 104-n being rendered non-operation owing to the failure of the asset. As described above, in examples, the loss of production may be estimated from the historic data or knowledge of the subject matter experts. The respective impact parameters of failure of one or more assets 104-1, 104-2, . . . , and 104-n involved in the industrial process may be defined during the process of FMEA, for example, by the process control system 108 and may be provided to the system 114. In another example, the impact parameters of failure of the one or more assets 104-1, 104-2, . . . , and 104-n may also be defined in the process control system 108 based on FMEA carried out by the subject matter experts. The communication module 308 of the system 114 may obtain such data from the process control system 108. Data related to impact parameters of failure of each asset 104-1, 104-2, . . . , and 104-n may be stored in the FMEA data 318 of the system 114.

Upon determining the impact parameter and availability of the standby asset, the fault prediction module 310 may determine the asset level degradation indicator for the asset by integrating component level degradation indicators and the subsystem level degradation indicators of each component and subsystems of the asset 104-1, 104-2, . . . , and 104-n, the impact parameter indicative of the impact of failure of the asset on the industrial process carried out in the industrial facility and the indication of availability of the standby asset using a third fusion function implementing data fusion. In an example, the third fusion function may be based on any one of fuzzy based fusion, Bayesian based fusion, Dempster Shafer fusion. The asset level degradation indicator may be determined in a normalized range such as 0-1, 0-10, 0-100 or 0-1000. For a fuzzy based fusion, a fuzzy membership function based on fuzzy operations such as fuzzy AND, fuzzy OR and fuzzy NOT may integrate the component level severity indicators and the subsystem level degradation indicators of each component and subsystems of the asset and the impact parameter indicative of impact of failure of the asset and indication of availability of standby asset to produce the component level degradation indicator in a normalized range such as 0-1.

In an example, the fault prediction module 310 may calculate or determine the asset level degradation indicator for each of the one or more assets 104-1, 104-2, . . . , and 104-n based on component level severity indicators and the subsystem level degradation indicators of the components and the subsystems of the respective asset 104-1, 104-2, . . . , and 104-n. In an example, the asset level degradation indicator of each asset 104-1, 104-2, . . . , and 104-n may be stored in the fault indication data 322 of the system 114. In case of above example of compressor, degradation indicator for compressor may be determined as 0.96766 by integrating degradation indicators for components and subsystems bearings, lube oil subsystem and seal subsystem.

In an example implementation of the present subject matter, based on the asset level degradation indicators of each asset 104-1, 104-2, . . . , and 104-n involved in the industrial process, the corrective action implementation module 312 may recommend one or more corrective actions which may comprise prioritizing and scheduling a maintenance operation to be carried out on at least one of the assets 104-1, 104-2, . . . , and 104-n. In an example, the recommended corrective action and schedule of maintenance operations to be carried out on the assets 104-1, 104-2, . . . , and 104-n may be stored in the corrective action data 324 of the system 114. The operator may be notified of the schedule of the maintenance operation, for example, based on a registered phone number or mail-id. In an example, the corrective action implementation module 312 may classify the asset level degradation indicators of each asset in plurality of zones. Each zone may correspond to a predefined range of values of the asset level degradation indicator. A color coding may be applied to each zone of the asset level degradation indicators to highlight the severity of degradation of the asset. For instance, a green zone may represent a safe and normal operation of an asset while a red zone may represent an unsafe and anomalous operation of the asset. In another example, a red zone, yellow zone and green zone may be indicative of high, medium and low priority, respectively, for carrying out a maintenance operation for the asset. The corrective action implementation module 312 may display, in a control room associated with the industrial process, the asset level degradation indicator in one of red zone, yellow zone and green zone, the red zone.

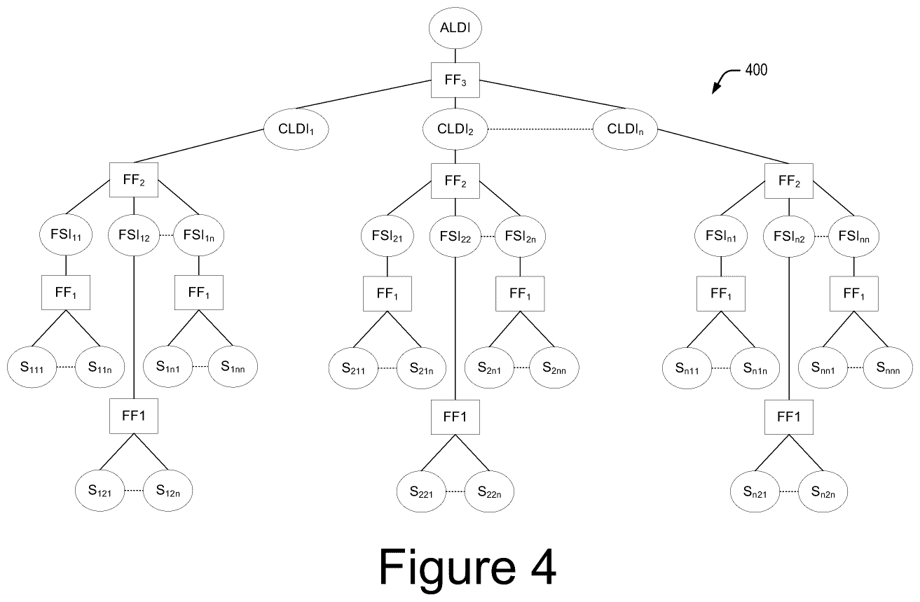

FIG. 4 illustrates a schematic representation of a process 400 involved in monitoring performance of an asset involved in an industrial process by the system 114. As described above, to monitor performance of the asset 104-1, the fault prediction module 310 of the system 114 may observe plurality of operating parameters of each of the one or more components 106-11, 106-12, . . . , and 106-1n of the asset 104-1 using data collected from the sensors 110-11, 110-12, . . . , and 110-1n attached to the one or more components. Data collected from the sensors comprises current values of operating parameters of the components. Based on the data collected from the sensors, one or more parameters of each component 106-11, 106-12, . . . , and 106-1n of the asset may be identified as deviating from corresponding mean values indicative acceptable values of operating parameters. Minimum and maximum bounds may be defined around the mean value to specify a tolerance of deviation. A threshold limit may also be specified for each operating parameter to indicate risk to wellbeing of the component. If a parameter deviates from corresponding mean value, it may be considered as a symptom of a fault that may likely to occur in the component during operation of the asset. One or more faults associated with a component of an asset and symptoms of each fault may be predefined through FMEA carried out, for example, by the system based on the historic data or expert's knowledge to identify potential failures of the asset.

In an example, once the symptoms of each fault of a component of the asset are identified, the fault prediction module 310 may assign a severity index to each symptom of a fault based on an amount of deviation from corresponding mean value. The severity index may be scaled up or down to conform to a normalized range such as 0-1. In an example, severity indexes SI₁₁₁, SI₁₁₂, . . . , and SI₁₁ₙ may be assigned to one or more symptoms of a first fault from amongst one or more faults associated with the component 106-11 of the asset 104-1. Similarly, severity indexes SI₁₂₁, SI₁₂₂, . . . , and SI₁₂ₙ may be assigned to one or more symptoms of a second fault associated with the component 106-11 of the asset 104-1 by the fault prediction system 310. Likewise, severity indexes SI₁ₙ₁, SI₁ₙ₂, . . . , and SI₁ₙₙ may be assigned to one or more symptoms of n^{th} fault of the component 106-11. In a similar manner, severity indexes (SI₂₁₁, SI₂₁₂, . . . , and SI₂₁ₙ), (SI₂₂₁, SI₂₂₂, . . . , and SI₂₂ₙ), . . . , and (SI₂ₙ₁, SI₂ₙ₂, . . . , and SI₂ₙₙ) may be assigned to symptoms of one or more respective faults of the second component 106-12 of the asset 104-1. Severity indexes (SIₙ₁₁, SIₙ₁₂, . . . , and SIₙ₁ₙ), (SIₙ₂₁, SIₙ₂₂, . . . , and SIₙ₂ₙ), . . . , and (SIₙₙ₁, SIₙₙ₂, . . . , and SIₙₙₙ) may be assigned to symptoms of one or more respective faults of a n^{th} component 106-1n of the asset 104-1.

Based on the severity indexes are assigned to symptoms of each fault of the component 106-11, the fault prediction module may determine fault severity indicator for each fault of the component. The fault severity indicator may be indicative of severity of the fault. Each fault can vary in severity depending on numerous factors, such as a number of symptoms of a fault, severity of each symptom or impact of fault on the performance of component or potential consequences for the overall asset operation. Thus, the fault severity indicator for a fault is determined taking these factors into account. For instance, the fault prediction module 310 may compute a weight of the fault may be computed based on a count of the symptoms of the fault, severity indexes of each symptom and an impact parameter indicative of an impact of the fault on operation of the component 106-11. The impact parameter reflects potential loss of production that would result if the component were to fail and render the asset non-operational. The loss of production may be estimated based on actual performance data of similar assets or feedback from maintenance activities. As described above, the impact parameter may be defined by the system 114 or the process control system 108 by carrying out the FMEA. The fault prediction module 310 may determine a fault severity indicator for the first fault associated with the first component 106-11 of the asset 104-1 by integrating severity indexes (SI₁₁₁, SI₁₁₂, . . . , and SI₁₁ₙ) of each symptom of the first fault and a weight of the first fault using a first fusion function FF₁. In an example, the fault severity indicators may be determined in a normalized range such as 0-1, 0-10, 0-100 or 0-1000. In this manner, fault severity indicators FSI₁₁, FSI₁₂, . . . , and FSI₁ₙ may be determined for one or more faults associated with the first component 106-11 of the asset 104-1. Likewise, fault severity indicators FSI₂₁, FSI₂₂, . . . , and FSI₂ₙ may be determined for one or more faults associated with the second component 106-12 of the asset 104-1 by integrating severity indexes of respective symptoms (SI₂₁₁, SI₂₁₂, . . . , and SI₂₁ₙ), (SI₂₂₁, SI₂₂₂, . . . , and SI₂₂ₙ), . . . , and (SI₂ₙ₁, SI₂ₙ₂, . . . , and SI₂ₙₙ). Fault severity indicators FSIₙ₁, FSIₙ₂, . . . , and FSIₙₙ may be determined for one or more faults associated with the n^{th} component 106-1n of the asset 104-1 by integrating severity indexes of respective symptoms (SIₙ₁₁, SIₙ₁₂, . . . , and SIₙ₁ₙ), (SIₙ₂₁, SIₙ₂₂, . . . , and SIₙ₂ₙ), . . . , and (SIₙₙ₁, SIₙₙ₂, . . . , and SIₙₙₙ).

Based on the fault severity indicators determined for faults associated with each component, the fault prediction module 310 may determine a component level degradation indicator for each component 106-11, 106-12, . . . , and 106-1n of the asset 104-1. The severity of degradation of a component within an asset can indeed be influenced by several factors, including the number of faults the component experiences, the severity of each individual fault or impact of component's failure on an overall operation of an asset. Accordingly, a weight of a failure of a component may be computed by the fault prediction module 310 based on a count of the faults having the corresponding fault severity indicators beyond a predetermined threshold and a predefined impact parameter indicative of an impact of a failure of the component on operation of the asset. A threshold value may be predefined for each fault to account for tolerance for deviations in values of operating parameters set by the minimum and maximum bounds for each parameter. The threshold value may be set based on the historic data. Further, the impact of failure of the component may be predefined by quantifying a potential loss of production associated with each component failure scenario based on historic data, expert's knowledge and feedbacks from past maintenance activities. The fault prediction module 310 may determine a component level degradation indicator CLDI₁ for the first component 106-11 of the asset 104-1 by integrating the fault severity indexes FSI₁₁, FSI₁₂, . . . , and FSI₁ₙ of one or more faults associated with the first component 106-11 and a weight of failure of the first component 106-11 using a second fusion function FF₂, for example, in a normalized range. A component level degradation indicator CLDI₂ may also be determined for the second component 106-12 of the asset 104-1 by integrating the fault severity indexes FSI₂₁, FSI₂₂, . . . , and FSI₂ₙ of one or more faults associated with the second component 106-12 and a weight of failure of the second component 106-12 using the second fusion function FF₂. In a similar manner, a component level degradation indicator CLDIₙ may be determined for the n^{th} component 106-1n of the asset 104-1 by integrating the fault severity indexes FSIₙ₁, FSIₙ₂, . . . , and FSIₙₙ of one or more faults associated with the n^{th} component 106-1n and a weight of failure of the n^{th} component 106-1n using the second fusion function FF₂.

Once the component level degradation indicator is determined for each component 106-11, 106-12, . . . , and 106-1n of the asset 104-1, the fault prediction module 310 may determine an asset level degradation indicator indicative severity of degradation of the asset. The severity of degradation of the asset accounts for various factors such as availability of a standby asset or impact of asset's failure on an overall operation of industrial process. If an asset's failure causes a significant disruption to operations, it may lead to downtime, delays in production or service delivery, financial losses, increased maintenance expenses, and potentially damage to reputation. Accordingly, based on these factors, a potential loss of production that may happen in the event of asset failure may be estimated. An impact parameter indicative of an impact of a failure of the asset on the industrial process may be defined, for example, by the system 114 or the process control system 108. The fault prediction module 310 may determine the asset level degradation indicator ALDI for the asset 104-1 by integrating the component level degradation indicators CLDI₁, CLDI₂, . . . , and CLDIₙ of each component 106-11, 106-12, . . . , and 106-1n of the asset 104-1, the impact parameter indicative and an indication that a standby asset for the asset is under maintenance. In an example, the first fusion function may be based on any one of fuzzy based fusion, Bayesian based fusion, Dempster Shafer fusion.

The process described above enables early and accurate fault detection which in turn enhances the resilience to asset failures and maintain continuity in operations.

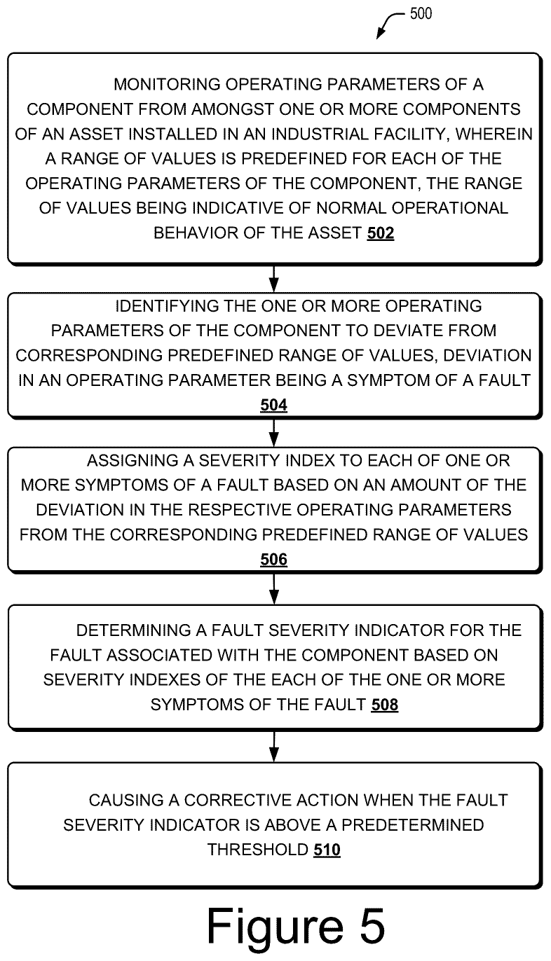

FIG. 5 illustrates a method 500 for managing performance of an asset installed in an industrial facility, according to an example. Although the method 500 may be implemented in a variety of computer-based systems, for the ease of explanation, the present description of the example method 500 to manage performance of the asset is provided in reference to the above-described system 114.

The order in which the method 500 is described is not intended to be construed as a limitation, and any number of the described method blocks may be combined in any order to implement the method 500, or an alternative method. Furthermore, the method 500 may be implemented by processor(s) or computing device(s) through any suitable hardware, non-transitory machine-readable instructions, or combination thereof.

It may be understood that blocks of the method 500 may be performed by programmed computing devices. The blocks of the method 500 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

Referring to FIG. 5, at block 502, operating parameters of a component from amongst one or more components of the asset, such as component 106-11 from amongst one or more components 106-11, 106-12, . . . , and 106-1n of the asset 104-2 installed in the industrial facility 102, are monitored. As discussed in the foregoing explanation, a range of values enclosed within a maximum and a minimum bound may be predefined for each of the operating parameters of the component 106-11. The range of values is indicative of normal operational behavior of the asset 104-1 or acceptable values of operating parameters of the component 106-11 that when adhered to, lead to a consistency and reliability in operation of an industrial process carried out in the industrial facility 102. Alternatively, a mean value may be defined to indicate acceptable values of operating parameters of values. A maximum and minimum bound may be defined in terms of a value or a percentage indicative of acceptable deviation from the mean value. In an example, the fault prediction module 310 of the system 114 may monitor operating parameters of the component 106-11. One or more sensors, such as sensor 110-11 connected to the component 106-11, may sense operating parameters of the respective components. A process control system 108 controlling operation of the industrial process within the industrial facility 102 may receive data related to operating parameters of the component 106-11 from the sensor 110-11. The communication module 308 of the system 114 may receive operating parameters of the component 106-11 either from the process control system 108 or from the respective sensors and make the data accessible to the fault prediction module 310 for monitoring.

At block 504, based on the data related to operating parameters of the component 106-11, one or more operating parameters of the component 106-11 may be identified to deviate from corresponding predefined range of values. In an example, the fault prediction module 310 of the system 114 may identify the deviation. Deviation in an operating parameter may be understood as a symptom of a fault from amongst one or more faults that may have been identified to potentially occur in the component 106-11. A fault in a component refers to a defect or anomaly in the component that may impair the component to perform intended function effectively and may be detected based on one or more associated symptoms. For instance, flow rate below a lower limit of the predefined operating range of values, may indicate seal failure in a pump.

At block 506, a severity index may be assigned, for example, by the fault prediction module 310, to each of one or more symptoms of the fault based on an amount of the deviation in the respective operating parameters from the corresponding predefined range of values. In an example, the severity index may be assigned by conforming the amount of deviation from the mean value to a normalized range, e.g., 0-1, 0-10 or 0-100.

Once the severity indexes have been assigned to each symptom of the fault, the method proceeds to block 508. At block 508, a fault severity indicator for the fault associated with the component 106-11 is determined based on severity indexes of the each of the one or more symptoms of the fault. In an example, the fault prediction module 310 may determine the fault severity indicator for the fault by integrating severity indexes of each symptom of the fault using data fusion operation.

At block 510, a corrective action may be caused when the fault severity indicator is above a predetermined threshold. In an example, corrective action implementation module 312 may cause the corrective action. In an example, a threshold value in the normalized range may be predefined for fault indicator of each fault to indicate the requirement of the corrective action on fault severity indicator exceeding the corresponding predefined threshold value. The threshold value of the fault severity indicator may be based on historic data related to past operation of the asset and knowledge of subject matter experts taking into consideration a minimum and maximum bound in the range of values predefined for each symptom of the fault. The corrective action may comprise various actions, such as raising alert notifications for operators of the asset 104-1 or stakeholders of the industrial facility 102 and scheduling a maintenance operation to be carried out on the asset 104-1 or the component 106-11 of the asset 104-1 to mitigate the risk associated with the fault.

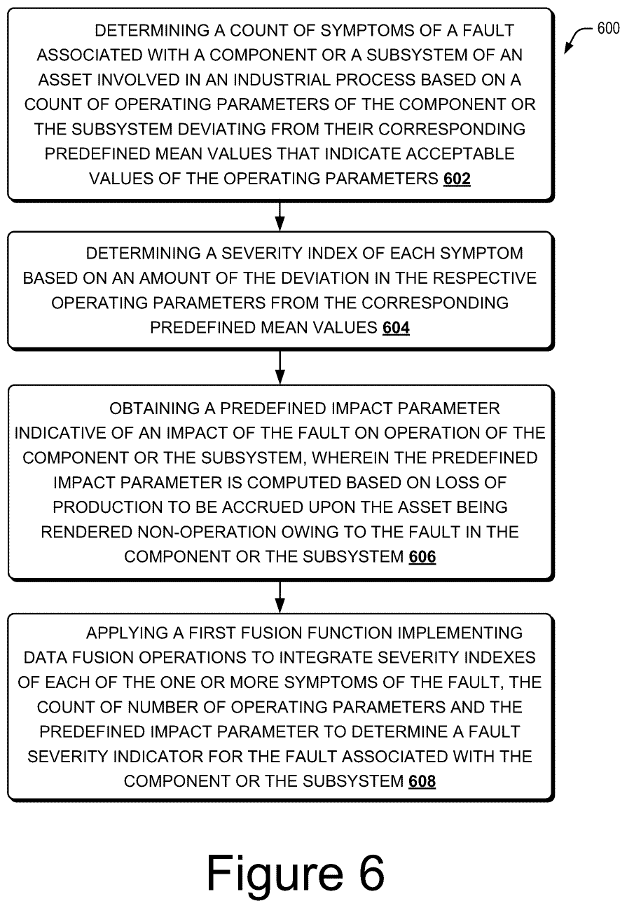

FIG. 6 illustrates a method 600 of determining a fault severity indicator for a fault associated with a component or subsystem of an asset, according to an example. Although the method 600 may be implemented in a variety of computer-based systems, for the ease of explanation, the present description of the example method 600 of determining the fault severity indicator for the fault is provided in reference to the above-described system 114.

The order in which the method 600 is described is not intended to be construed as a limitation, and any number of the described method blocks may be combined in any order to implement the method 600, or an alternative method. Furthermore, the method 600 may be implemented by processor(s) or computing device(s) through any suitable hardware, non-transitory machine-readable instructions, or combination thereof.

It may be understood that blocks of the method 600 may be performed by programmed computing devices. The blocks of the method 600 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

To monitor asset performance in an industrial process, which may occur in an industrial facility like the industrial facility 102, operating parameters of the components and subsystems 106-11, 106-12, . . . , and 106-1n of asset the 104-1 may be tracked. This tracking may utilize data on current parameter values collected from sensors 110-11, 110-12, . . . , and 110-1n attached to the components or the subsystems. For each operating parameter of the component or subsystem 106-11, a mean value may be established using historical operational data and expert knowledge. Minimum and maximum bounds may be set around this mean, defining an acceptable range of values for each operating parameter. In some instances, a threshold limit indicating safety risk for the asset 104-1, or the component or subsystem 106-11 may be specified for each operating parameter, potentially by the asset's manufacturer based on factors like performance capability or design of the asset.

A parameter deviation outside the predefined range for the component or subsystem 106-11 may indicate a symptom of a potential fault associated with that component or subsystem. A fault may be considered an anomaly in the component or the subsystem 106-11 and may be identified through one or more symptoms. The fault's severity may vary based on factors such as the number of symptoms, the severity of each symptom, or its impact on the component's or subsystem's performance. In some cases, the cumulative effect of multiple symptoms over time may also influence the fault's severity.

Referring to FIG. 6, at block 602, based on the monitoring, a count of symptoms of the fault associated with the component or subsystem 106-11 of the asset 104-1 is determined, for example, by the fault prediction module 310 of the system 114, based on a count of operating parameters of the component or subsystem 106-11 deviating from their corresponding predefined mean values that indicate acceptable values of the operating parameters. For example, noise, vibration and heat generation may be caused in a bearing as a result of excessive wear. Deviations in values of operating parameters namely, noise, vibration and heat generation or temperature may be considered as symptoms of a fault, i.e., excessive wear of the bearing. If all of the parameters, noise, vibration, or heat generation are identified to be deviating from their corresponding predefined mean values, a count of the symptoms of the fault, ‘excessive wear of the bearing’, may be determined as 3.

At block 604, a severity index of each symptom may be determined, for example, by the fault prediction module 310 based on an amount of the deviation in the respective operating parameters from the corresponding predefined mean values.

As discussed previously, the value of the severity index may be conformed to a normalized range, e.g., of 0-1. Suppose during a manufacturing process, as per the SOP, the temperature of a reactor should be maintained at a mean value of 100° C. and a range of 100° C.±5° C. indicates acceptable values of temperature. However, due to a fault in a temperature control system of the reactor, the actual temperature is measured as 110° C. which deviates from the mean value by 10° C. which is significantly above the mean 100° C. Such a magnitude of deviation could lead to thermal degradation of products, asset's failure, or even safety hazards due to excessive pressure buildup or chemical reactions becoming uncontrolled in case of the present example of the reactor. Thus, the magnitude or degree of deviation from the predefined mean, and not merely the occurrence of the deviation, is recorded by the fault prediction module 310 for accurate computation of the severity index.

Further, each fault can vary in severity, ranging from minor malfunctions to critical failures, based on factors, such as the nature of the fault, its impact on the component's performance, and the potential consequences for the overall asset operation. To take into consideration these factors while determining severity indicator of the fault, at block 606, a predefined impact parameter indicative of an impact of the fault on operation of the component or subsystem 106-11 may be obtained, for example, by the fault prediction module 310. The predefined impact parameter is computed based on loss of production to be accrued upon the asset being rendered non-operation owing to the fault in the component or the subsystem 106-11. The loss of production may be estimated based on the past operation of a similar asset 104-1, as discussed above.

At block 608, a first fusion function implementing data fusion operations may be applied to integrate severity indexes of each of the one or more symptoms of the fault, the count of number of operating parameters and the predefined impact parameter to determine a fault severity indicator for the fault associated with the component or subsystem 106-11. In an example, the fault prediction module 310 may determine the fault severity indicator of the fault. The fault severity indicator may be determined in a normalized range such as 0-1, 0-10, 0-100 or 0-1000. In an example, the first fusion function may be based on any one of fuzzy based fusion, Bayesian based fusion, Dempster Shafer fusion. Accordingly, the method provides an accurate and reliable estimation of the severity of a fault to aid in predictive and preventive maintenance of the corresponding asset 104-1 or the component or subsystem 106-11 of the asset 104-1.

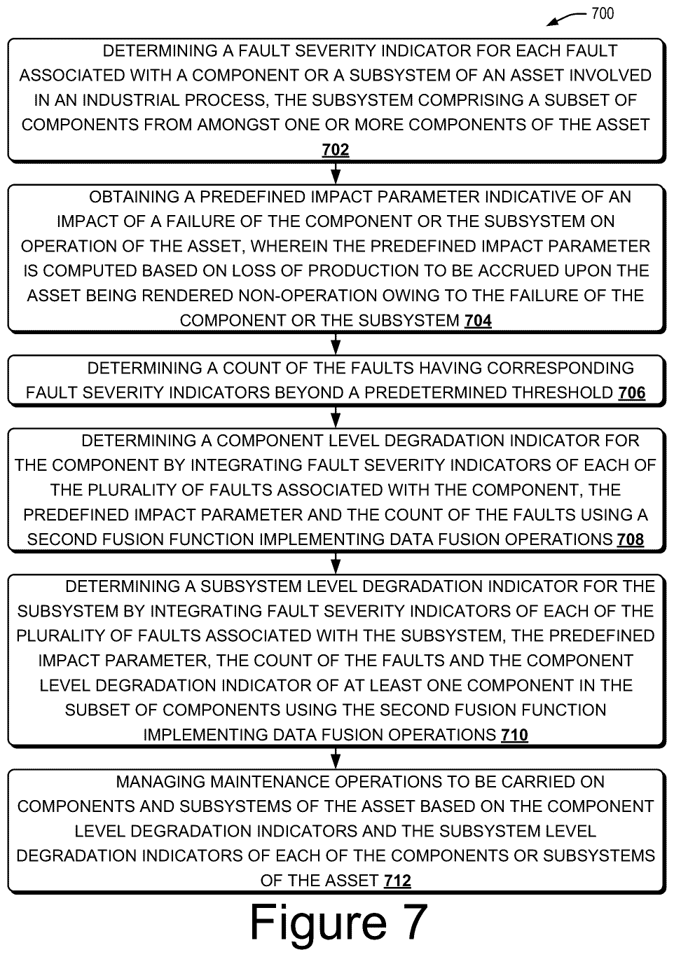

FIG. 7 illustrates a method 700 of managing maintenance operations for components and subsystems of an asset involved in an industrial process, according to an example. Although the method 700 may be implemented in a variety of computer-based systems, for the ease of explanation, the present description of the example method 700 of managing maintenance operations for components and subsystems of the asset is provided in reference to the above-described system 114.

The order in which the method 700 is described is not intended to be construed as a limitation, and any number of the described method blocks may be combined in any order to implement the method 700, or an alternative method. Furthermore, the method 700 may be implemented by processor(s) or computing device(s) through any suitable hardware, non-transitory machine-readable instructions, or combination thereof.

It may be understood that blocks of the method 700 may be performed by programmed computing devices. The blocks of the method 700 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

To manage maintenance operations for components and subsystems of the asset 104-1 involved in the industrial process, at block 702, a fault severity indicator is determined for each fault associated with a component or subsystem 106-11 of the asset 104-1 using the method explained in reference to FIG. 6.

Having the fault severity indicator determined for each fault of the component or subsystem 106-11, a component level degradation indicator or subsystem level degradation indicator, as the case may be, for the component or subsystem 106-11 may be determined. The component level degradation indicator or the subsystem level degradation indicator is indicative of severity of probability of failure of the component or the subsystem 106-11. Probability of failure of a component or subsystem 106-11 of an asset 104-1 is influenced by various factors, such as the number of faults that have occurred in the component or subsystem 106-11 and the severity of each individual fault. The cumulative impact of multiple faults on a component or subsystem 106-11 can significantly affect its overall probability of failure. If a component or subsystem 106-11 experiences multiple faults over time, it can lead to a gradual degradation of performance or functionality of the component or subsystem 106-11. Also, failure of a component or subsystem 106-11 may have less severe impact on the performance of asset in comparison to other components and subsystems of the asset 104-1. Accordingly, to determine component level degradation indicator or subsystem level degradation indicator for the component or subsystem 106-11, at block 704, a predefined impact parameter indicative of an impact of a failure of the component or subsystem 106-11 on operation of the asset 104-1 may be obtained, for example, by the fault prediction module 310. In an example, the predefined impact parameter may be computed based on loss of production that may be incurred if the asset 104-1 is rendered non-operation owing to the failure in the component or the subsystem. As discussed above, the loss of production may be estimated, for instance, by subject matter experts based on the historic data.

At block 706, a count of the faults having the corresponding fault severity indicators beyond a predetermined threshold is determined, for example, by the fault prediction module 310. In an example, a threshold value may be predefined for fault severity indicator of the component or subsystem 106-11. The threshold value may signify when corrective action becomes necessary to mitigate the risk associated with the fault in the component or subsystem 106-11. The threshold value for a fault may be established based on historical data, taking into account the tolerance for deviations in values of respective operating parameters from their mean values, as indicated by the maximum and minimum bounds of the corresponding predefined range of values. In determining this threshold, various factors may be considered, such as the component's criticality, the potential impact of failure, and the system's overall risk tolerance. In an example, the threshold value may be dynamically adjusted over time as more operational data becomes available or as the system's requirements change.

At block 708, a component level degradation indicator for the component 106-11 may be determined by integrating the fault severity indicators of each of the plurality of faults associated with the component 106-11, the predefined impact parameter and the count of the faults using a second fusion function implementing data fusion operations. In an example, the component level degradation indicator may be determined by the fault prediction module 310. In an example, the second fusion function may be based on any one of fuzzy based fusion, Bayesian based fusion, Dempster Shafer fusion. The component level degradation indicator may be determined in a normalized range such as 0-1, 0-10, 0-100 or 0-1000.

Further, as described with reference to FIG. 3, a subsystem may be connected to one or more components, or subset of components, of the asset to perform an intended function of facilitating operation of the components. Thus, faults in the subsystem affect and introduce faults in at least one component. Correspondingly, component level degradation indicators of the at least one component may be indicative of a fault of the subsystem and contribute to the subsystem level degradation indicator of the subsystem. Thus, at block 710, a subsystem level degradation indicator for the subsystem 106-11 may be determined by integrating the fault severity indicators of each of the plurality of faults associated with the subsystem 106-11, the predefined impact parameter, the count of the faults and the component level degradation indicators of the one or more components using the second fusion function implementing data fusion operations. In an example, the subsystem level degradation indicator may be determined by the fault prediction module 310. The subsystem level degradation indicator may be determined in a normalized range such as 0-1, 0-10, 0-100 or 0-1000.

At block 712, maintenance operations to be carried on components and subsystems of the asset 104-1 are managed, for example, by the corrective action implementation module 312, based on the component level degradation indicators and subsystem level degradation indicators of each of the components and subsystems of the asset 104-1. To manage maintenance operations, a schedule for the maintenance operations may be prepared based on the component level degradation indicators and subsystem level degradation indicators and may be communicated to a service personnel or operator on a registered mail-id or phone number. The schedule may be prepared based on variety of factors such as time period during which the asset remains in non-working state to minimize the downtime that may take place as a result of performance of a maintenance activity.

In some cases, the maintenance schedule may prioritize components or subsystems with higher degradation indicators or those critical to overall asset performance. The schedule may also consider factors such as the availability of replacement parts, skilled technicians, and the potential impact on production schedules. Additionally, the system may suggest predictive maintenance interventions based on trends in the degradation indicators, potentially preventing failures before they occur and optimizing the asset's operational efficiency.

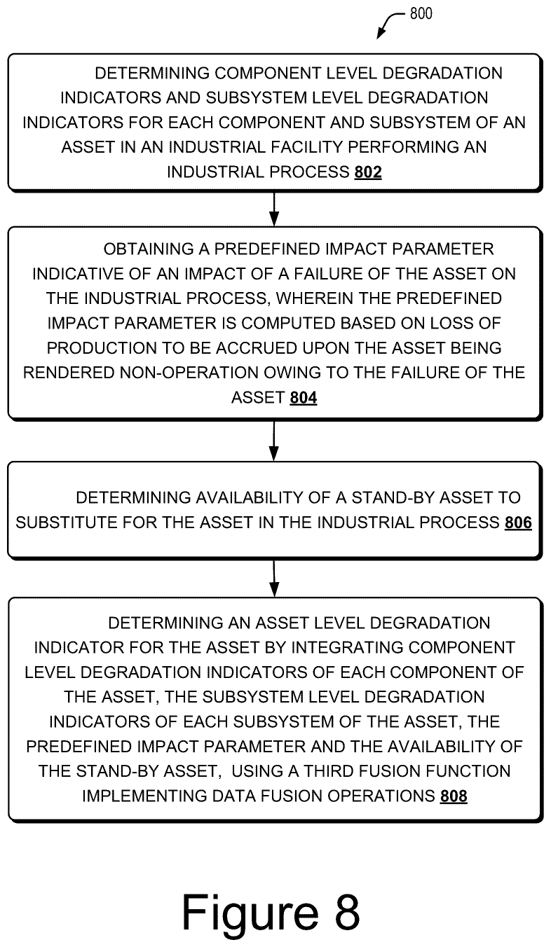

FIG. 8 illustrates a method 800 of determining an asset level degradation indicator of an asset involved in an industrial process, according to an example. Although the method 800 may be implemented in a variety of computer-based systems, for the ease of explanation, the present description of the example method 800 of determining the asset level degradation indicator of the asset is provided in reference to the above-described system 114.

The order in which the method 800 is described is not intended to be construed as a limitation, and any number of the described method blocks may be combined in any order to implement the method 800, or an alternative method. Furthermore, the method 800 may be implemented by processor(s) or computing device(s) through any suitable hardware, non-transitory machine-readable instructions, or combination thereof.

It may be understood that blocks of the method 800 may be performed by programmed computing devices. The blocks of the method 800 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

To determining the asset level degradation indicator of the asset involved in the industrial process, at block 802, a component level degradation indicator and a subsystem level indicator, as the case may be, for each component or subsystem 106-11 of the asset 104-1 in an industrial facility 102 performing the industrial process is determined using the method explained in reference to FIG. 7.

Once the component level degradation indicators and subsystem level degradation indicators is determined for each component and subsystem of the asset 104-1, an asset level degradation indicator, indicative of severity of degradation of the asset 104-1 may be determined. Severity of degradation of an asset varies in relation to other assets involved in the industrial process based on variety of factors such as interdependence of other assets, criticality of the asset, availability of standby or backup asset.

The interdependence of assets may play a crucial role in determining failure severity. In some cases, the failure of one asset may have cascading effects on interconnected assets, potentially amplifying the overall impact on the industrial process. The degree of this interdependence may vary, ranging from minimal to highly integrated systems where the failure of a single asset could lead to widespread disruptions. Asset criticality may significantly influence the severity of failure. Some assets may be deemed more critical due to their central role in the production process, their high replacement cost, or their impact on product quality. The failure of a highly critical asset may result in more severe consequences compared to a less critical one.

Accordingly, to determine the asset level degradation indicator for the asset 104-1, at block 804, a predefined impact parameter indicative of an impact of a failure of the asset 104-1 on the industrial process may be obtained, for example, by the fault production module 310. The predefined impact parameter is computed based on loss of production to be accrued upon the asset being rendered non-operation owing to the failure of the asset 104-1. Loss of production may be estimated based on the historic data and the knowledge of the subject matter expert. Based on the loss of production, the impact parameter may be computed during FMEA process that may be conducted for the industrial process, for example, by the system 114.

At block 806, availability of a stand-by asset to substitute for the asset 104-1 in the industrial process may be determined, for example, by the fault prediction module 310. The availability of standby or backup assets may mitigate the severity of a failure. In some instances, redundant systems or readily available replacement assets may allow for quick recovery and minimal disruption to the industrial process. However, the effectiveness of these backup solutions may depend on factors such as their capacity, readiness, and the time required for switchover. In an example, a process control system 108 controlling operation of the industrial process within the industrial facility 102 may provide an indication of the availability of a standby asset. In another example, the availability of the stand-by asset to substitute for the asset 104-1 may be determined based on a user input.

At block 808, an asset level degradation indicator for the asset 104-1 may be determined by integrating component level degradation indicators and subsystem level degradation indicators of each component and subsystem of the asset 104-1, the predefined impact parameter and the availability of the stand-by asset, using a third fusion function implementing data fusion. Fuzzy based fusion may allow for the handling of imprecise or uncertain information about asset degradation, providing a more nuanced representation of the overall asset condition. In an example, the fault prediction module 310 may determine the asset level degradation indicator for the asset 104-1. In an example, the third fusion function may be based on any one of fuzzy based fusion, Bayesian based fusion, Dempster Shafer fusion. The asset level degradation indicator may be determined in a normalized range such as 0-1, 0-10, 0-100 or 0-1000. The normalization facilitates easier interpretation and comparison of degradation levels across different assets or systems.

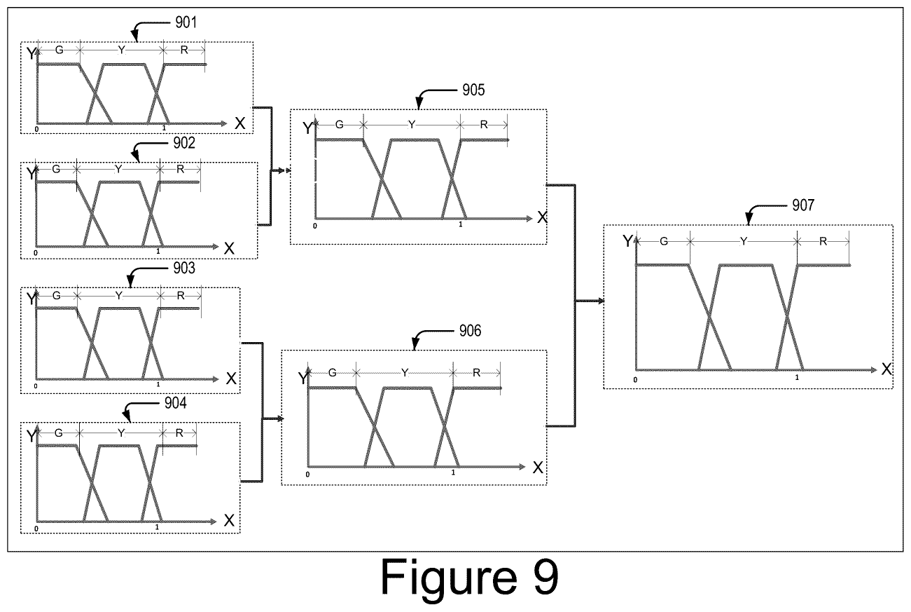

FIG. 9 illustrates a graphical representation of estimation of component level severity indicators for components: drive end bearing, non-drive end bearing, and rotor of an asset, namely, a compressor or pump. The component drive end bearing may have an associated fault, such as drive end bearing fault. The drive end bearing fault may be identified based on a symptom of anomalous temperature and vibration of the drive end bearing. While, the non-drive end bearing may have associated fault, such as drive end bearing fault which may be identified based on a symptom of anomalous temperature and vibration of the non-drive end bearing. The temperature and vibrations of the drive end and non-end bearings may be measured by the corresponding sensors to identify deviation from a corresponding mean value. If a deviation is identified in the temperature or vibration of the drive end or non-drive end bearing, a severity index of the corresponding symptom may be determined based on the respective deviation in a normalized range. In one instance, normalized value can be calculated by the equation 1.

A fuzzy membership function may be defined for normalized values of each deviation or severity index. Graphs 901-904 indicate graphical representation of the fuzzy membership functions of severity indexes of symptoms: drive end bearing temperature, drive end bearing vibration, non-drive end bearing temperature and non-drive end bearing vibration, respectively. Normalized values or severity indexes of symptoms: drive end bearing temperature, drive end bearing vibration, non-drive end bearing temperature and non-drive end bearing vibration collected or determined over different instances of times are depicted on X axis of the graphs 901-904, while corresponding fuzzy membership values according to fuzzy function membership function are depicted over Y axis. Fault severity indicator for the drive end bearing fault may be determined by integrating severity indexes of the drive end bearing vibration and drive end bearing temperature using data fusion operations, such as fuzzy fusion operations. Similarly, fault severity indicator for the non-drive end bearing fault may be determined by integrating severity indexes of the non-drive end bearing vibration and non-drive end bearing temperature using data fusion operations, such as fuzzy fusion operations. Graphs 905 and 906 indicate the fuzzy membership functions of fault indicators for drive end bearing fault and non-drive end bearing fault, respectively. Fault indicators for drive end bearing fault and non-drive end bearing fault, determined in a normalized range of 0-1 are depicted on X axis of the graphs 905 and 906, respectively, while corresponding fuzzy membership values according to fuzzy function membership function are depicted over Y axis. Component level degradation indicators for the components drive end bearing and non-drive end bearing may be determined based on the drive end bearing fault and non-drive end bearing fault, respectively. Faults in the bearings connected at the drive end and non-drive end sides of the rotor in the compressor may also be indicative of faults for the rotor. Accordingly, the drive end bearing fault and the non-drive end bearing fault may also be considered as faults for the rotor. Accordingly, component level degradation indicator for the component rotor may be determined by integrating the drive end bearing fault and non-drive end bearing fault using the data fusion operations, such as fuzzy fusion operations. Graph 907 indicates the fuzzy membership function of component level degradation indicator for the component rotor. X axis of the graph depicts component level degradation indicator of rotor determined based on the values of graphs 905 and 906 in a normalized range of 0-1, while Y axis depicts corresponding fuzzy membership values mapped according to fuzzy function membership function. In each of the graphs 901-907, values of the parameters represented on x axis, i.e., normalized values of drive end bearing temperature, drive end bearing vibration, non-drive end bearing temperature and non-drive end bearing vibration, drive end bearing fault indicator, non-drive end bearing fault indicator and component level degradation indicator for rotor, respectively, can be classified in green, yellow, and red zones as represented through numerals G, Y and R, respectively. As discussed above, the red zone, yellow zone and green zone may be indicative of high, medium and low priority, respectively, for carrying out a maintenance operation for the asset or the component or subsystem of the asset.

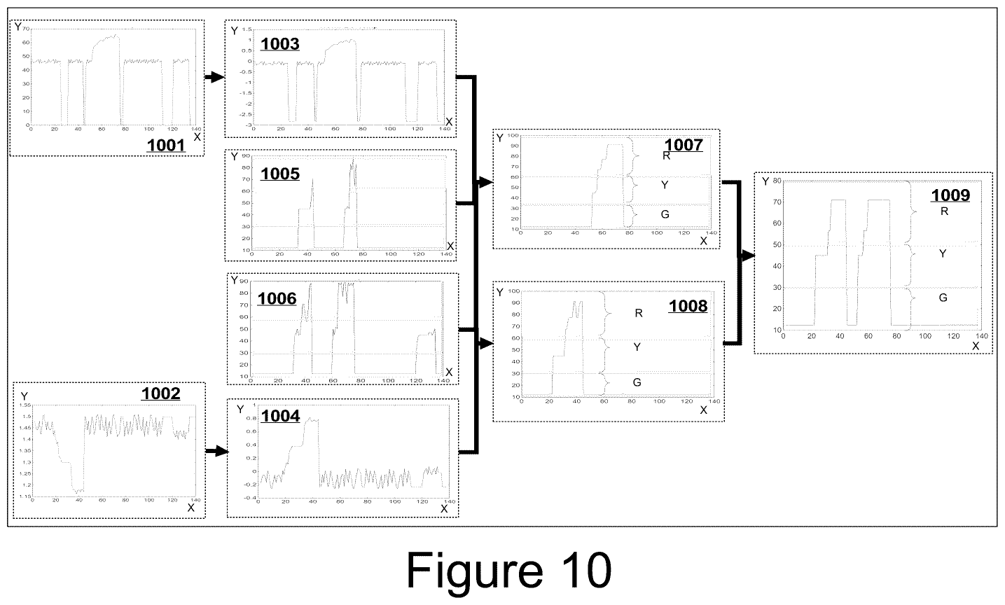

FIG. 10 illustrates graphical representation of estimation of subsystem level degradation indicator for a subsystem of an asset, compressor. The compressor, in addition to the components drive end and non-drive end bearings, may have subsystems, such as a lube oil subsystem. Y axis of graph 1001 shows actual measured values from a thermal sensor measuring the lube oil subsystem's header temperature at different instances of time as depicted over X axis. While Y axis of graph 1002 shows actual measurements of a lube oil header pressure from a pressure transmitter at different instances of time as depicted over X axis. Symptoms of anomalous temperature and pressure at header of the lubrication oil subsystem may be indicative of lube oil subsystem faults. Deviation in measured values of lube oil header temperature and pressure from a corresponding mean value may indicate symptoms of faults of the lube oil subsystem. Deviation in measured values of header temperature and pressure may be conformed to a normalized value in a range of 0 to 1 as indicated along Y axis of graphs 1003 and 1004, respectively. These normalized values indicate severity indexes of symptoms lube oil header temperature and pressure. Graphs 1005 and 1006 indicate component level degradation indicators for the drive end and non-drive end bearings, respectively, determined in a normalized range of 0-100 using data collected over multiple instances of time as depicted over Y axis of corresponding graph.

As described with reference to FIG. 3, component level degradation indicators of the components to which the subsystem is connected may serve as symptoms of a fault of the subsystem or fault indicators for faults of the subsystem. High value of header temperature and low value of header pressure of the lube oil subsystem are detrimental to the health of the bearings and there are threshold limits for alarming operators. Since the effect of high value of temperature and low value of header pressure is higher bearing vibration or temperature, the component level degradation indicators for the drive end and non-drive end bearing are used as an effect or secondary damage for the faults of the lube oil subsystem. Accordingly, the normalized values represented in graphs 1003-1006 may be infused or integrated using data fusion operation to determine fault indicators for faults of the lube oil subsystem, such as lube oil cooling and lube oil pressure loss. In an example, the normalized values or the severity index of the symptom lube oil header temperature, as represented in graph 1003, and component level degradation indicators for the components drive end bearing and non-drive end bearing, as represented in graphs 1005 and 1006, respectively, may be integrated using data fusion operations to determine fault severity indicator for the fault lube oil cooling. While the normalized values or the severity index of the symptom lube oil header pressure, as represented in graph 1004, and component level degradation indicators for the components drive end bearing and non-drive end bearing, as represented in graphs 1005 and 1006, respectively, may be integrated using data fusion operations to determine fault severity indicator for the fault lube oil pressure loss.

Graphs 1007 and 1008 represent fault severity indicators for the faults lube oil cooling and lube oil pressure loss, respectively, along Y axis of corresponding graph, which may further be fused or integrated to determine subsystem level degradation indicator for the lube oil subsystem as represented along Y axis of the graph 1009. The values of fault severity indicators for the faults lube oil cooling and lube oil pressure loss and subsystem level degradation indicator for lube oil subsystem are normalized in a normalized range of 0-100 with 0 being in good condition and 100 means in bad condition as represented on y axis of corresponding graphs 1007, 1008 and 1009, respectively. These values may be classified in green, yellow, and red zones as represented through numerals G, Y and R, respectively. A limit of 0-30 may indicate normal value indicated through G, a 30-60 indication may be considered as bad condition of the subsystem represented through Y and a value between 60-100 may be considered as a critical condition requiring urgent maintenance of the subsystem as represented through R.

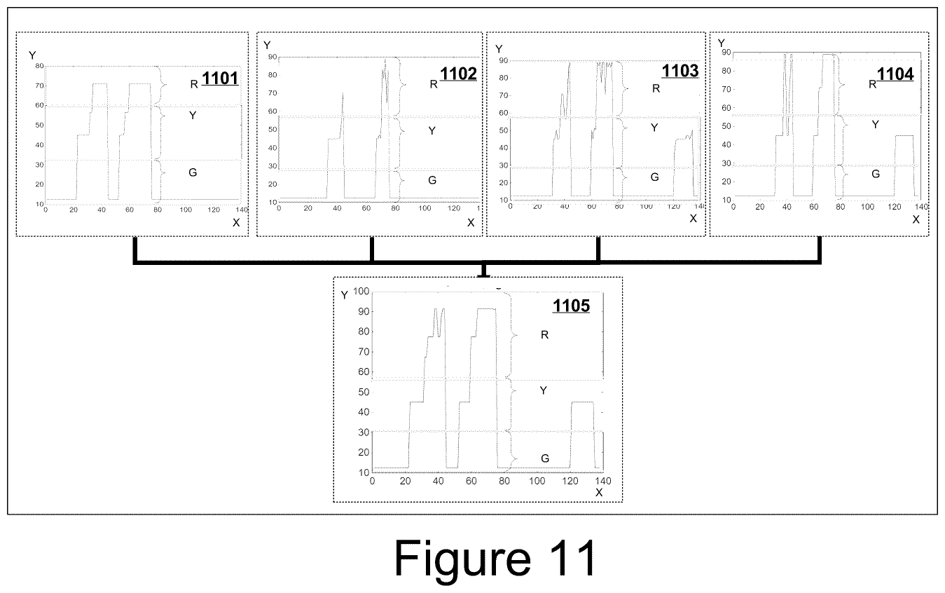

FIG. 11 illustrates graphical representation of estimation of asset level degradation indicator for the asset compressor. In the depicted example, the asset level degradation indicator for the compressor is determined by integrating individual subsystem level degradation indicator for the subsystem, such as lube oil subsystem as represented along Y axis of graph 1101, and component level degradation indicators for the components, namely, drive end bearing, non-drive end bearing and rotor as represented along Y axis of graphs 1102, 1103 and 1104, respectively, using data fusion operations. The values of degradation indicators depicted in graphs 1101-1104 are determined using data collected over multiple instances of times as depicted over X axis of corresponding graph. Graph 1105 indicates the values of asset level degradation indicator for the compressor along Y axis. There may be other subsystems, such as seal subsystem, gearbox subsystem and their degradation indicators can also be integrated using fusion techniques to estimate the asset level degradation indicator. The values of subsystem level degradation indicator for lube oil subsystem, and component level degradation indicators for the components drive end bearing, non-drive end bearing, and rotor are normalized in a normalized range of 0-100 with 0 being in good condition and 100 means in bad condition as represented on Y axis of corresponding graphs 1101, 1102, 1103 and 1104, respectively. These values may be classified in green zone with limit of 0-30 indicating normal value, yellow zone with limit of 30-60 indicating bad condition, and red zone with limit 60-100 indicating critical condition as represented through numerals G, Y and R, respectively.

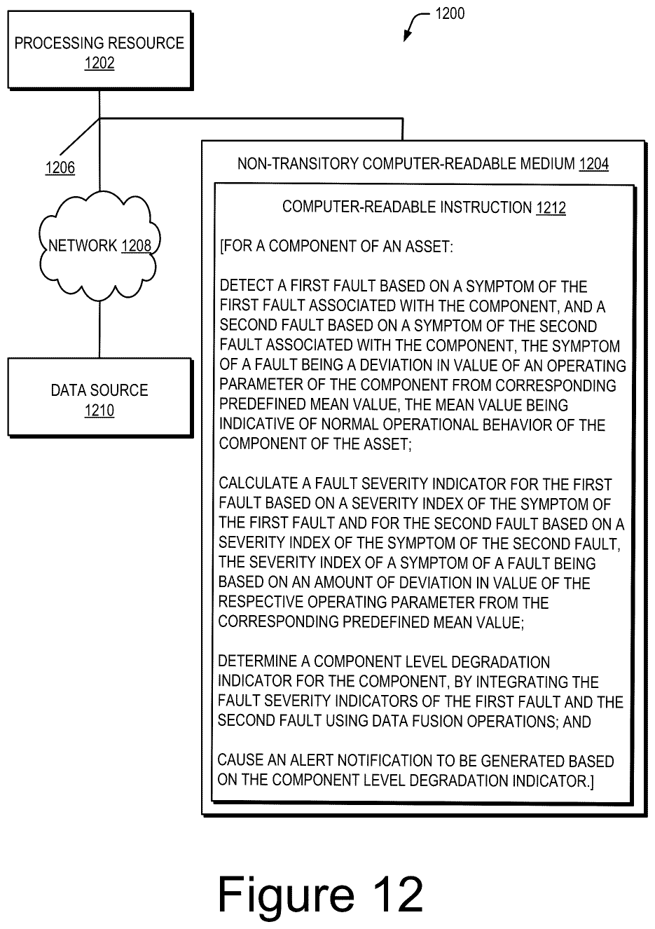

FIG. 12 illustrates a computing environment 1200 for managing performance of assets in an industrial facility, according to an example. In an example implementation, the computing environment 1200 may comprise a computing device, such as the above-described system 114. The computing environment 1200 includes a processing resource 1202 communicatively coupled to the non-transitory computer-readable medium 1204 through a communication link 1206. In an example, the processing resource 1202 may be a processor of the computing device, such as the processor 202 of the system 114, that fetches and executes computer-readable instructions from the non-transitory computer-readable medium 1204.

The non-transitory computer-readable medium 1204 can be, for example, an internal memory device or an external memory device. In an example implementation, the communication link 1206 may be a direct communication link, such as any memory read/write interface. In another example implementation, the communication link 1206 may be an indirect communication link, such as a network interface. In such a case, the processing resource 1202 can access the non-transitory computer-readable medium 1204 through a network 1208. The network 1208 may be a single network or a combination of multiple networks and may use a variety of different communication protocols.

The processing resource 1202 and the non-transitory computer-readable medium 1204 may also be communicatively coupled to data sources 1210. In an example implementation, the non-transitory computer-readable medium 1204 comprises executable instructions 1212 for managing performance of the assets 104-1, 104-2, . . . , and 104-n installed in the industrial facility 102. The assets 104-1, 104-2, . . . , and 104-n may be involved in carrying out an industrial process in the industrial facility. Each asset 104-1, 104-2, . . . , and 104-n may comprise one or more components such as the asset 104-1 comprises the components 106-11, 106-12, . . . , and 106-1n. To manage performance of the assets 104-1, 104-2, . . . , and 104-n, operating parameters of the component 106-11 of the asset 104-1 may be monitored through a corresponding sensor such as the sensor 110-11. A mean value may be predefined for each operating parameter of a component 106-11 of an asset 104-1 to indicate normal operational behavior of the component 106-11 of the asset 104-1. During monitoring operating parameters of the component 106-11 of the asset 104-1, one or more operating parameters may be identified to deviate from corresponding predefined mean value. Deviation in an operating parameter of the component 106-11 from corresponding predefined mean value may be understood as a symptom of a fault from amongst one or more faults associated with the component 106-11. The fault may be understood as an anomaly in the component 106-11 or the asset 104-1.

In an example, the instructions 1212 may cause the processing resource 1202 to detect a first fault based on a symptom of the first fault associated with the component 106-11, and a second fault based on a symptom of the second fault associated with the component 106-11. As mentioned above, a symptom of a fault is a deviation in value of an operating parameter of the component 106-11 from corresponding predefined mean value which is indicative of normal operational behavior of the component 106-11. In an example, the instructions 1212 may cause the processing resource 1202 to calculate a fault severity indicator for the first fault based on a severity index of the symptom of the first fault and for the second fault based on a severity index of the symptom of the second fault. In an example, the severity index of a symptom of a fault may be determined in a normalized range such as 0-1, 0-10 or 0-100, based on an amount of deviation in value of the respective operating parameters from the corresponding predefined mean values.

In an example, the instructions 1212 may further cause the processing resource 1202 to determine a component level degradation indicator for the component 106-11 by integrating the fault severity indicators of the first fault and the second fault using data fusion operations. In an example, the data fusion operations may be based on any one of fuzzy based fusion, Bayesian based fusion, Dempster Shafer fusion. The component level degradation indicator may be determined in a normalized range such as 0-1, 0-10, 0-100 or 0-1000.

Thereafter, the instructions 1212 may cause the processing resource 1202 to cause an alert notification to be generated based on the component level degradation indicator. In an example, an operator or a service personnel may be notified regarding the severity highlighted by the component level degradation indicator through a registered mail-id or phone number. For example, different communication channels may be used based on the urgency and severity of the degradation indicator. For instance, critical alerts might trigger immediate phone calls or text messages, while less urgent notifications could be sent via email. In another example, a message may be displayed in a control room to notify the operator. In an example, the instructions 1212 may also cause the processing resource 1202 to cause a maintenance operation to be scheduled for components of the asset based on the component level degradation indicators of each component of the asset. The operator may be notified of the schedule of the maintenance operation to be carried out on the asset or components of the asset via the alert notification.

In some implementations, the alert notification may include detailed information about the component's condition, such as specific fault types detected, historical degradation trends, and recommended maintenance actions. This information may help recipients make informed decisions about how to respond to the alert. The alert notification may also include options for the recipient to acknowledge receipt, request additional information, etc.

In an example, the instructions 1212 may also cause the processing resource 1202 to compute an asset level degradation indicator for the asset 104-1 based on component level degradation indicators computed for each component of the asset 104-1. The asset level degradation indicator for the asset 104-1 may be computed in a normalized range by integrating component level degradation indicators of each component of the asset 104-1 using data fusion operations. The asset level degradation indicator for the asset 104-1 may be computed in a normalized range by integrating component level degradation indicators of each component of the asset 104-1 using data fusion operations. In a similar manner, the instructions 1212 may also cause the processing resource 1202 to compute asset level degradation indicators for each asset involved in an industrial process. In an example, the instructions 1212 may further cause the processing resource 1202 to classify each asset based on the asset level degradation indicators in one of red zone, yellow zone and green zone. The red zone, yellow zone and green zone may be indicative of high, medium and low priority of the corresponding asset, respectively, for carrying out a maintenance operation. In an example, the asset level degradation indicators may be displayed in a control room associated with the industrial process in the red, yellow or green zone.

Accordingly, techniques described herein enable early fault detection through monitoring a degree of deviation of operating parameters of various components of the assets. Also, a comprehensive degradation assessment of components and assets using advanced fusion techniques described herein provides for an accurate estimation of health of the assets or probability of failure of the assets or components of the assets. Corrective actions may be prioritized based on the degradation assessment of the assets.

Thus, the methods and systems of the present subject matter provide for managing performance of assets involved in an industrial process. Although implementations of managing performance of assets involved in an industrial process have been described in a language specific to structural features and/or methods, it is to be understood that the appended claims are not necessarily limited to the specific features or methods described. Rather, the specific features and methods are disclosed as example implementations of managing performance of assets involved in an industrial process.

1. A method for managing performance of an asset installed in an industrial facility, the method comprising:
monitoring, operating parameters of a component from amongst one or more components of the asset, wherein a range of values is predefined for each of the operating parameters of the component, the range of values being indicative of normal operational behavior of the asset;
identifying, one or more operating parameters of the component to deviate from corresponding predefined range of values, deviation in an operating parameter being a symptom of a fault;
assigning, a severity index to each of one or more symptoms of the fault based on an amount of the deviation in the respective operating parameters from the corresponding predefined range of values;
determining, a fault severity indicator for the fault associated with the component based on the severity indexes of the each of the one or more symptoms of the fault; and
causing a corrective action when the fault severity indicator is above a predetermined threshold.

2. The method as claimed in claim 1, wherein assigning the severity index to each of one or more symptoms of the fault comprises conforming the severity index to a normalized range based on an amount of deviation in the respective operating parameters from a mean of the corresponding predefined range of values.

3. The method as claimed in claim 1, wherein determining the fault severity indicator for the fault associated with the component further comprises:
calculating a weight of the fault based on a predefined value indicative of an impact of the fault on the corresponding component of the asset, a count of the one or more symptoms of the fault and the severity indexes of the one or more symptoms of the fault; and
determining the fault severity indicator by integrating the severity indexes of each of the one or more symptoms of the fault and the weight of the fault using a first fusion function implementing data fusion operations.

4. The method as claimed in claim 3 further comprising:
determining, a fault severity indicator for each fault from amongst a plurality of faults associated with the component;
calculating a weight of a failure of the component based on a predefined value indicative of an impact of the failure of the component on the asset, a number of the faults and the fault severity indicators of each fault associated with the component; and
determining, a component level degradation indicator for the component by integrating the fault severity indicators of each of the plurality of faults associated with the component and the weight of the failure of the component using a second fusion function implementing data fusion operations.

5. The method as claimed in claim 4 further comprising:
determining a fault severity indicator for a fault associated with a subsystem from amongst one or more subsystems of the asset based on monitoring operating parameters of the subsystem, wherein the subsystem comprises a subset of components from amongst one or more components of the asset.

6. The method as claimed in claim 5 further comprising:
determining, a fault severity indicator for each fault from amongst a plurality of faults associated with the subsystem;
calculating a weight of a failure of the subsystem based on a predefined value indicative of an impact of the failure of the subsystem on the asset, a number of the faults and the fault severity indicators of each fault associated with the subsystem; and
determining, a subsystem level degradation indicator for the subsystem by integrating the fault severity indicators of each of the plurality of faults associated with the subsystem, the component level degradation indicator of at least one component in the subset of components of the subsystem and the weight of the failure of the subsystem using the second fusion function.

7. The method claimed in claim 6 further comprising:
determining, an asset level degradation indicator for the asset by integrating the component level degradation indicators of each component of the asset, the subsystem level degradation indicators of each subsystem of the asset, a predefined value indicative of an impact of a failure of the asset on an industrial process carried out in the industrial facility and an indication that a standby asset for the asset is under maintenance using a third fusion function implementing data fusion operations.

8. The method as claimed in claim 7, wherein each of the first, the second and the third fusion function is based on any one of fuzzy based fusion, Bayesian based fusion, Dempster Shafer fusion.

9. The method as claimed in claim 7 further comprising:
causing the corrective action of scheduling a maintenance operation to be carried out on at least one of the components and subsystems of the asset based on at least one of the component level degradation indicators, the subsystem level degradation indicators and the asset level degradation indicators.

10. A system for managing performance of assets involved in an industrial process, the system comprising:
a processor to:
for a component or a subsystem of an asset, determine a first severity index of a first symptom of a fault associated with the component or the subsystem based on an amount of deviation in value of a first operating parameter of the component or the subsystem from a corresponding predefined mean value indicative of acceptable values of the first operating parameter;
determine a second severity index of a second symptom of the fault based on an amount of deviation in value of a second operating parameter of the component or the subsystem from a corresponding predefined mean value indicative of acceptable values of the second operating parameter;
calculate a fault severity indicator for the fault associated with the component or the subsystem by integrating the first severity index and the second severity index using data fusion operations; and
cause an alert notification to be generated based on the fault severity indicator of the fault.

11. The system as claimed in claim 10, wherein the processor is to:
calculate, a fault severity indicator for each of one or more faults associated with the component or the subsystem based on the severity indexes of symptoms of the corresponding fault associated with the component or the subsystem; and
compute, a component level degradation indicator for the component, by integrating the fault severity indicators of each of the one or more faults associated with the component using data fusion operations.

12. The system as claimed in claim 11, wherein the processor is to:
compute a component level degradation indicator for each of one or more components of the asset based on the fault severity indicators of each fault associated with the respective components of the asset;
determine, a subsystem level degradation indicator for the subsystem by integrating the fault severity indicators of each of the plurality of faults associated with the subsystem, and the component level degradation indicators of each component in a subset of components of the subsystem using the data fusion operations; and
compute, an asset level degradation indicator for the asset by applying data fusion operations on the component level degradation indicators of each component of the asset and the subsystem level indicators of each subsystem of the asset.

13. The system as claimed in claim 12, wherein the processor is to:
prioritize a maintenance operation to be carried based on at least one of the component level degradation indicators and the subsystem level degradation indicators.

14. The system as claimed in claim 12, wherein the processor is to:
prioritize a maintenance operation to be carried on at least one of the assets based on the asset level degradation indicator of each asset in the industrial facility.

15. The system as claimed in claim 10, wherein the processor is to:
display, in a control room associated with the industrial process, the fault severity indicator in one of plurality of zones, wherein a zone in the plurality of zones corresponds to a predefined range of values of the fault severity indicator.

16. The system as claimed in claim 12, wherein the processor is to:
display, in the control room, the asset level degradation indicator in one of red zone, yellow zone and green zone, the red zone, yellow zone and green zone being indicative of high, medium and low priority, respectively, for carrying out a maintenance operation for the asset.

17. A non-transitory computer-readable medium comprising instructions executable by a processing resource to:
for a component of an asset:
detect a first fault based on a symptom of the first fault associated with the component, and a second fault based on a symptom of the second fault associated with the component, the symptom of a fault being a deviation in value of an operating parameter of the component from corresponding predefined mean value, the mean value being indicative of normal operational behavior of the component of the asset;
calculate a fault severity indicator for the first fault based on a severity index of the symptom of the first fault and for the second fault based on a severity index of the symptom of the second fault, the severity index of a symptom of a fault being based on an amount of deviation in value of the respective operating parameter from the corresponding predefined mean value;
determine a component level degradation indicator for the component, by integrating the fault severity indicators of the first fault and the second fault using data fusion operations; and
cause an alert notification to be generated based on the component level degradation indicator.

18. The non-transitory computer-readable medium as claimed in claim 17, wherein the computer-readable instructions are executable by the processing resource to:
compute an asset level degradation indicator for the asset based on component level degradation indicators computed for each component of the asset.

19. The non-transitory computer-readable medium as claimed in claim 18, wherein the computer-readable instructions are executable by the processing resource to
cause a maintenance operation to be scheduled for components of the asset based on the component level degradation indicators of each component of the asset.

20. The non-transitory computer-readable medium as claimed in claim 18, wherein the computer-readable instructions are executable by the processing resource to:
compute asset level degradation indicators for each asset involved in an industrial process; and
classify each asset based on the asset level degradation indicators in one of red zone, yellow zone and green zone, the red zone, yellow zone and green zone being indicative of high, medium and low priority of the corresponding asset, respectively, for carrying out a maintenance operation.
